(19) United States
(12) Patent Application Publication
(10) Pub. No.: US 2023/0291441 A1
(43) Pub. Date: Sep. 14, 2023

(54) SIGNALING TO AID ENHANCED NR TYPE II CSI FEEDBACK

(71) Applicant: Telefonaktiebolaget LM Ericsson (publ), Stockholm (SE)

(72) Inventors: Siva Muruganathan, Stittsville (CA); Fredrik Athley, Kullavik (SE); Mattias Frenne, Uppsala (SE); Shiwei Gao, Nepean (CA); Helka-Liina Määttänen, Helsinki (FI); Xinlin Zhang, Göteborg (SE)

(21) Appl. No.: 18/015,360

(22) PCT Filed: Jul. 9, 2021
(86) PCT No.: PCT/IB2021/056202

§ 371 Date: Jan. 10, 2023

Related U.S. Application Data
(60) Provisional application No. 63/050,550, filed on Jul. 10, 2020.

(51) Int. Cl. H04B 7/0417; H04B 7/0456; H04W 72/23; H04L 5/00

(52) U.S. Cl. CPC H04B 7/0417; H04B 7/0456; H04W 72/23; H04L 5/0051; H04B 7/0626

(57) ABSTRACT

Methods for reporting Channel State Information (CSI) from a wireless device to a radio network node are provided. More specifically, the wireless device receives an indication indicating a subset of Frequency Domain (FD) basis vectors among a full set of FD basis vectors from the radio network node. Accordingly, the wireless device computes a CSI corresponding to an enhanced type II port selection codebook using the indicated subset of FD basis vectors and report the CSI to the radio network node. The methods disclosed herein make it possible to reduce complexity and signaling overheat for reporting CSI based on the selected subset of FD basis vectors.

### RELATED APPLICATIONS

This application claims the benefit of provisional patent application serial number 63/050,550, filed Jul. 10, 2020, the disclosure of which is hereby incorporated herein by reference in its entirety.

### TECHNICAL FIELD

The technology of the disclosure relates generally to signaling for frequency and spatial domain bases indication to aid enhanced New Radio (NR) Type II Channel State Information (CSI) feedback using angle and delay reciprocity.

### BACKGROUND

### Codebook-Based Precoding

Multi-antenna techniques can significantly increase data rates and reliability of a wireless communication system. The performance is particularly improved if both transmitter and receiver are equipped with multiple antennas, which results in a Multiple-Input Multiple-Output (MIMO) communication channel. Such systems and/or related techniques are commonly referred to as MIMO.

The NR standard is currently evolving with enhanced MIMO support. A core component in NR is the support of MIMO antenna deployments and MIMO related techniques such as spatial multiplexing. The spatial multiplexing mode is aimed for high data rates in favorable channel conditions. An illustration of spatial multiplexing operation is provided in FIG. 1.

As seen, information carrying symbol vector s is multiplied by an N_{T}×r precoder matrix W, which serves to distribute the transmit energy in a subspace of the N_{T} (corresponding to N_{T} antenna ports) dimensional vector space. The precoder matrix is typically selected from a codebook of possible precoder matrices, and typically indicated by means of a Precoder Matrix Indicator (PMI), which specifies a unique precoder matrix in the codebook for a given number of symbol streams. The r symbols in s each correspond to a layer and r is referred to as the transmission rank. In this way, spatial multiplexing is achieved since multiple symbols can be transmitted simultaneously over the same Time/Frequency Resource Element (TFRE). The number of symbols r is typically adapted to suit the current channel properties.

NR uses Orthogonal Frequency Division Multiplexing (OFDM) in the downlink (and DFT precoded OFDM in the uplink for rank-1 transmission) and hence the received N_{R}×1 vector yₙ for a certain TFRE on subcarrier n (or alternatively data TFRE number n) is thus modeled by:

yₙ=HₙWsₙ+eₙ

where eₙ is a noise/interference vector obtained as realizations of a random process. The precoder W can be a wideband precoder, which is constant over frequency or frequency selective.

The precoder matrix W is often chosen to match the characteristics of the N_{R}×N_{T} MIMO channel matrix Hₙ, resulting in so-called channel dependent precoding. This is also commonly referred to as closed-loop precoding and essentially strives for focusing the transmit energy into a subspace, which is strong in the sense of conveying much of the transmitted energy to the UE.

In closed-loop precoding for the NR downlink, the UE transmits, based on channel measurements in the downlink, recommendations to the gNB of a suitable precoder to use. The gNB configures the UE to provide feedback according to CSI-ReportConfig and may transmit Channel State Information (CSI)-Reference Signal (RS) (CSI-RS) and configure the UE to use measurements of CSI-RS to feedback recommended precoding matrices that the UE selects from a codebook. A single precoder that is supposed to cover a large bandwidth (wideband precoding) may be fed back. It may also be beneficial to match the frequency variations of the channel and instead feedback a frequency-selective precoding report (e.g., several precoders) one per subband. This is an example of the more general case of CSI feedback, which also encompasses feeding back other information than recommends precoders to assist the gNodeB in subsequent transmissions to the UE. Such other information may include Channel Quality Indicators (CQIs) as well as transmission Rank Indicators (RI). In NR, CSI feedback can be either wideband, where one CSI is reported for the entire channel bandwidth, or frequency-selective, where one CSI is reported for each subband. Herein, a subband is defined as a number of contiguous resource blocks ranging between 4-32 PRBS depending on the Bandwidth Part (BWP) size.

Given the CSI feedback from the UE, the gNB determines the transmission parameters the gNB wishes to use to transmit to the UE, including the precoding matrix, transmission rank, and Modulation and Coding Scheme (MCS). These transmission parameters may differ from the recommendations the UE made. The transmission rank, and thus the number of spatially multiplexed layers, is reflected in the number of columns of the precoder W. For efficient performance, it is important that a transmission rank that matches the channel properties is selected.

### 2D Antenna Arrays

The disclosure presented may be used with two-dimensional antenna arrays, and some of the presented embodiments use such antenna arrays. Such antenna arrays may be (partly) described by the number of antenna columns corresponding to the horizontal dimension Nₕ, the number of antenna rows corresponding to the vertical dimension Nᵥ, and the number of dimensions corresponding to different polarizations Nₚ. The total number of antennas is thus=NₕNᵥNₚ. It should be pointed out that the concept of an antenna is non-limiting in the sense that it can refer to any virtualization (e.g., linear mapping) of the physical antenna elements. For example, pairs of physical sub-elements could be fed the same signal, and hence share the same virtualized antenna port.

An example of a 4×4 array with dual-polarized antenna elements is illustrated in FIG. 2.

Precoding may be interpreted as multiplying the signal with different beamforming weights for each antenna prior to transmission. A typical approach is to tailor the precoder to the antenna form factor, for example, taking into account Nₕ, Nᵥ, and Nₚ when designing the precoder codebook.

### Channel State Information Reference Signals (CSI-RS)

For CSI measurement and feedback, CSI-RS are defined. A CSI-RS is transmitted on each antenna port and is used by a User Equipment (UE) to measure a downlink channel between each of the transmit antenna ports and each of the receive antenna ports in the UE. The transmit antenna ports are also referred to as CSI-RS ports. The supported number of antenna ports in NR are {1,2,4,8,12,16,24,32}. By measuring the received CSI-RS, a UE can estimate the channel that the CSI-RS is traversing, including radio propagation channel and antenna gains. The CSI-RS for the above purpose is also referred to as Non-Zero Power (NZP) CSI-RS.

CSI-RS can be configured to be transmitted in certain resource elements (REs) in a slot and certain slots. FIG. 3 shows an example of CSI-RS REs for 12 antenna ports, where 1RE per RB per port is shown.

In addition, Interference Measurement Resource (IMR) is also defined in NR for a UE to measure interference. An IMR resource contains 4 REs, either 4 adjacent REs in frequency in the same OFDM symbol or 2 by 2 adjacent REs in both time and frequency in a slot. By measuring both the channel based on NZP CSI-RS and the interference based on an IMR, a UE can estimate the effective channel and noise plus interference to determine the CSI (e.g., rank, precoding matrix, and channel quality).

Furthermore, a UE in NR may be configured to measure interference based on one or multiple NZP CSI-RS resource.

### CSI Framework in NR

In NR, a UE can be configured with multiple CSI reporting settings and multiple CSI-RS resource settings. Each resource setting can contain multiple resource sets, and each resource set can contain up to 8 CSI-RS resources. For each CSI reporting setting, a UE feeds back a CSI report.

Each CSI reporting setting contains at least the following information:
A CSI-RS resource set for channel measurement
An IMR resource set for interference measurement
Optionally, a CSI-RS resource set for interference measurement
Time-domain behavior, i.e., periodic, semi-persistent, or aperiodic reporting
Frequency granularity, i.e., wideband or subband
CSI parameters to be reported such as RI, PMI, CQI, and CSI-RS Resource Indicator (CRI) in case of multiple CSI-RS resources in a resource set
Codebook types, i.e., Type I or II, and codebook subset restriction
Measurement restriction
Subband size. One out of two possible subband sizes is indicated, the value range depends on the bandwidth of the BWP. One CQI/PMI (if configured for subband reporting) is fed back per subband).

When the CSI-RS resource set in a CSI reporting setting contains multiple CSI-RS resources, one of the CSI-RS resources is selected by a UE and a CRI is also reported by the UE to indicate to the gNB about the selected CSI-RS resource in the resource set, together with RI, PMI and CQI associated with the selected CSI-RS resource.

For aperiodic CSI reporting in NR, more than one CSI reporting setting, each with a different CSI-RS resource set for channel measurement and/or resource set for interference measurement can be configured and triggered at the same time. In this case, multiple CSI reports are aggregated and sent from the UE to the gNB in a single Physical Uplink Shared Channel (PUSCH).

### NR Rel-16 Enhanced Type II Port Selection Codebook

The enhanced Type II (eType II) Port Selection (PS) codebook was introduced in Rel-16, which is intended to be used for beamformed CSI-RS, where each CSI-RS port covers a small portion of the cell coverage area with high beamforming gain (compared to non-beamformed CSI-RS). Although it is up to the gNB implementation, it is usually assumed that each CSI-RS port is transmitted in a 2D spatial beam that has a main lobe with an azimuth pointing angle and an elevation pointing angle. The actual precoder matrix used for CSI-RS is transparent to the UE. Based on the measurement, the UE selects the best CSI-RS ports and recommends to gNB to use for DL transmission. The eType II PS codebook can be used by the UE to feedback the selected CSI-RS ports, and as a way to combine the selected CSI-RS ports. The configured CSI-RS ports can be considered as a set of Spatial Domain (SD) basis, and a subset of the SD basis is determined and reported back by the UE.

### Structure, Configuration and Reporting of eType II PS Codebook

For a given transmission layer l, with l∈{1, . . . , v} and v being the RI, the precoder matrix for all Frequency Domain (FD)-units is given by a size P_{CSI-RS}×N₃ (i.e., P_{CSI-RS} rows and N₃ columns) matrix Wₗ, where:
P_{CSI-RS} is the number of single-polarized CSI-RS ports.
N₃=N_{SB}×R is the number of PMI subbands, where
   The value R={1,2} (the PMI subband size indicator) is RRC configured.
   N_{SB} is the number of CQI subbands, which is also RRC configured.
The RI value v is set according to the configured higher layer parameter typeII-RI-Restriction-r16. UE shall not report v>4.

The precoder matrix Wₗ can be factorized as Wₗ=W₁\tilde{W}_{2,l}W_{f,l}^{H}, and Wₗ is normalized such that ∥Wₗ∥_{F}=1√v, for l=1, . . . , v.

Port selection matrix Wₗ: Wₗ is a size P_{CSI-RS}×2L port selection precoder matrix that can be factorized into

$${W}_{1} = {W}_{PS} ⊗ [ \begin{matrix}1 & 0 \\ 0 & 1\end{matrix} ] ,$$

where:
W_{PS} is a size

$$\frac{{P}_{CSI - RS}}{2} \times L$$

port selection matrix consisting of 0s and 1s. Selected ports are indicated by 1s which are common for both polarizations.
L is the number of selected CSI-RS ports per polarization. Supported L values can be found in Table 1.
Selected CSI-RS ports are jointly determined by two parameters d and 11,1. Starting from the 11,1-th port, only every d-th port can be selected (note that port numbering is up to gNB to decide).
   The value of d is configured with the higher layer parameter portSelectionSamplingSize, where d∈{1, 2, 3, 4} and

$$d < min ( \frac{{P}_{CSI - RS}}{2} , L ) .$$

The value of i_{1,1}, where

$${i}_{1 , 1} ∈ \{ 0 , 1 , … , ⌈ \frac{{P}_{CSI - RS}}{2 d} ⌉ - 1 \} ,$$

is determined by UE based on CSI-RS measurement. UE shall feed back the chosen i_{1,1} to gNB.
Wₗ is common for all layers.

Frequency-domain compression matrix W_{f,l}: W_{f,l} is a size N₃×MᵥFD-domain compression matrix for layer l, where:

$${M}_{v} = ⌈ {p}_{v} \frac{{N}_{3}}{R} ⌉$$

is the number of selected FD basis vectors, which depends on the rank indicator v and the RRC configured parameter pᵥ. Supported values of pᵥ can be found in Table 1.
w_{f,l}=[f_{0,l}, f_{1,l}, . . . f_{Mv,l}], where {fk,l}ₖ₌₀^{Mv-1} are Mᵥ size N₃×1 FD basis vectors that are selected from N₃ orthogonal DFT basis vectors {yt}ₜ₌₀^{N3-1} with size N₃×1.
   For N₃≤19, a one-step free selection is used.
      For each layer, FD basis selection is indicated with a

$$⌈ {log}_{2} ( \begin{matrix}{N}_{3} - 1 \\ {M}_{v} - 1\end{matrix} ) ⌉$$

bit combinatorial indicator. In TS 38.214, the combinatorial indicator is given by the index i_{1,6,l} where I corresponds to the layer index. This combinatorial index is reported by UE to the gNB per layer per PMI.
For N₃>19, a two-step selection with a layer-common intermediary subset (IntS) is used.
   In this first step, a window-based layer-common IntS selection is used, which is parameterized by Mᵢₙᵢₜᵢₐₗ. The IntS consists of FD basis vectors mod(Mᵢₙᵢₜᵢₐₗ+n, N₃), where=0,1, . . . , N′₃−1 and N′₃=2Mᵥ. In TS 38.214, the selected IntS is reported by the UE to the gNB via the parameter i_{1,5}, which is reported as part of the PMI.
   The second step subset selection is indicated by an

$$⌈ {log}_{2} ( \begin{matrix}{N}_{3}^{′} - 1 \\ {M}_{v} - 1\end{matrix} ) ⌉ -$$

bit combinatorial indicator for each layer in Part 2 of the CSI report. In TS 38.214, the combinatorial indicator is given by the index i_{1,6,l} where l corresponds to the layer index. This combinatorial index is reported by UE to the gNB per layer per PMI.
W_{f,1} is layer-specific.

Linear combination coefficient matrix \tilde{W}_{2,l}:
\tilde{W}_{2,l} is a size 2L×Mᵥ matrix that contains 2LMᵥ coefficients for linearly combining the selected Mᵥ FD basis vectors for the selected 2L CSI-RS ports.
For layer l, only a subset of Kₗ^{NZ}≤K₀ coefficients are non-zero and reported. The remaining 2LMᵥ−Kₗ^{NZ} non-reported coefficients are considered zero.
   K₀=┌β×2LM₁┐ is the maximum number of non-zero coefficients per layer, where β is a RRC configured parameter. Supported β values are shown in Table 1.
   For v∈{2, 3, 4}, the total number of non-zero coefficients summed across all layers, Kₜₒₜ^{NZ}=Σₗ₌₁^{v}Kₗ^{NZ}, shall satisfy Kₜₒₜ^{NZ}≤2K₀.
   Selected coefficient subset for each layer is indicated with Kₗ^{NZ} in a size 2LMᵥ bitmap, which is included in Part 2 of the CSI report.
   Indication of Kₜₒₜ^{NZ}, where Kₜₒₜ^{NZ}∈{1, 2, . . . , 2K₀}, is included in Part of the CSI report, so that payload of Part 2 of the CSI report can be known.
The amplitude and phase of coefficients in \tilde{W}_{2,l} shall be quantized for reporting.
\tilde{W}_{2,l} is layer-specific.

TABLE 1
Rel-16 eType II PS codebook parameter
configurations for L, pᵥ and β

| | |
|---|---|
| paramCombination- | p_{υ} |

| r16 | L | υ ∈ {1, 2} | υ ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |

### FDD-Based Reciprocity Operation

In Frequency Division Duplex (FDD) operation, the Uplink (UL) and Downlink (DL) transmissions are carried out on different frequencies, thus the propagation channels in UL and DL are not reciprocal as in the Time Division Duplex (TDD) case. Despite this, some physical channel parameters, e.g., delays and angles to different clusters, which depend on the spatial properties of the channel but not the carrier frequency, are reciprocal between UL and DL. Such properties can be exploited to obtain partial reciprocity based FDD transmission. The reciprocal part of the channel can be combined with the non-reciprocal part in order to obtain the complete channel. An estimate of the non-reciprocal part can be obtained by feedback from the UE.

One procedure for reciprocity based FDD transmission scheme is illustrated in FIG. 4 in 4 steps, assuming that NR Re1.16 enhanced Type II port-selection codebook is used.

In Step 1, the UE is configured with SRS by gNB and the UE transmits SRS in the UL for the gNB to estimate the angles and delays of different clusters, which are associated with different propagation paths.

In Step 2, in a gNB implementation algorithm, the gNB selects dominant clusters according to the estimated angle-delay power spectrum profile, and, for each of the selected cluster, gNB precodes (e.g., beamforms) and transmits to the UE, one CSI-RS port per polarization according to the obtained angle and/or delay estimation.

In Step 3, the gNB has configured the UE to measure a CSI-RS, and the UE measures the received CSI-RS ports and then determines a type II CSI including RI, PMI for each layer and CQI. The precoding matrix indicated by the PMI includes the selected beams (e.g., the precoded CSI-RS ports) and the corresponding best phase and amplitude for co-phasing the selected beams. The phase and amplitude for each beam are quantized and feed-back to the gNB.

In Step 4, the gNB implementation algorithm computes the DL precoding matrix per layer based on the selected beams and the corresponding amplitude and phase feedback and performs Physical Downlink Shared Channel (PDSCH) transmission. The transmission is based on the feed-back (PMI) precoding matrices directly (e.g., SU-MIMO transmission) or the transmission precoding matrix is obtained from an algorithm combining CSI feedback from multiple UEs (MU-MIMO transmission). In this case, a precoder derived based on the precoding matrices (including the CSI reports from co-scheduled UEs) (e.g., Zero-Forcing precoder or regularized ZF precoder). The final precoder is commonly scaled so that the transmit power per power amplifier is not overridden.

Such reciprocity-based transmission can potentially be utilized in a codebook-based DL transmission for FDD in order to, for example, reduce the feedback overhead in UL when NR Type II port-selection codebook is used. Another potential benefit is reduced complexity in the CSI calculation in the UE.

### Type II Port Selection Codebook for FDD Operation Based on Angle/Delay Reciprocity

If the Re1.16 enhanced Type II port-selection codebook is used for FDD operation based on angle and/or delay reciprocity, the FD basis W_{f} still needs to be determined by the UE. Therefore, in the CSI report, the feedback overhead for indicating which FD bases are selected can be large, especially when N₃, the number of PMI subbands, is large. Also, the computational complexity at the UE for evaluating and selecting the best FD bases also increases as N₃ increases.

In a method proposed outside the present disclosure, the delay reciprocity between UL and DL, the gNB is utilized to pre-determine a subset of FD basis \tilde{W}_{f} based on the estimated delay information to the selected clusters in UL. Then, the gNB can indicate to the UE about this pre-determined subset of FD basis \tilde{W}_{f}. The UE can then evaluate and select FD basis vectors within the pre-determined subset.

In a method proposed outside the present disclosure, the gNB determines the angles and delays of the different clusters by analyzing the angle-delay power spectrum of the channel. For example, the 8×10 grid in the left part of FIG. 5 shows the angle-delay power spectrum of an UL channel with 8 angle bins and 10 delay taps, where each shaded square represents the power level for a given cluster at a certain angle and delay. Based on angle reciprocity, gNB selects, in this example, 2 strongest clusters and precodes one CSI-RS port per polarization for transmission towards each cluster (i.e., a total of 4 CSI-RS ports). In the right part of FIG. 5, there are only 4 taps in the delay domain in the two beamformed channels (i.e., the two beamformed channels correspond to the two selected clusters), while in the original channel there are 10 taps. Therefore, the 4 delay taps that remain, which can be translated to an FD basis with 4 vectors, \tilde{W}_{f}=[fₖ_{₀}fₖ_{₁} . . . fₖ_{₃}], can be conveyed by the gNB to the UE, such that the UE only needs to select the best frequency basis vectors from the 4 FD basis vector candidates instead of 10. Thus, in this example, the overhead for indicating what FD bases are selected can be decreased, and the computation complexity at the UE for selecting the best FD bases can be reduced.

In another method proposed outside the present disclosure, the gNB pre-compensates the delays for each beamformed channel such that the strongest path in all beamformed channels arrives at the UE at the same time. As seen in FIG. 6, after pre-compensating the delay for the beamformed channels, the number of delay taps reduces to 3 in the two beamformed channels corresponding to the two selected clusters. This is in contrast to the 10 delay taps in the raw channel. Moreover, since the zeroth delay component (which corresponds to the zeroth FD basis vector, i.e., DC basis) always exists, gNB only needs to signal the UE the remaining 2 FD basis vectors \tilde{W}_{f}=[fₖ_{₀}fₖ_{₁}]. Hence, the UE only needs to select the best frequency basis vectors from the 2 FD basis vector candidates instead of 4 as in the case of the example in FIG. 5. Thus, in this example, not only the overhead for indicating which FD components that have been selected is reduced, but also the overhead in reporting corresponding LC coefficients from the UE to the gNB can be reduced. Additionally, the computational complexity at the UE for selecting the best FD bases can be reduced.

Hence, the previously proposed solution can be used to reduce the CSI feedback overhead for indicating which FD basis vectors are used, and also the corresponding phase and amplitude for combining the selected FD and SD basis. The previously proposed solution also reduces the computational complexity for the UE to select the best FD basis vectors.

### SUMMARY

Embodiments disclosed herein include methods for reporting Channel State Information (CSI) from a wireless device to a radio network node. More specifically, the wireless device receives an indication indicating a subset of Frequency Domain (FD) basis vectors among a full set of FD basis vectors from the radio network node. Accordingly, the wireless device computes a CSI corresponding to an enhanced type II port selection codebook using the indicated subset of FD basis vectors and report the CSI to the radio network node. The methods disclosed herein make it possible to reduce complexity and signaling overheat for reporting CSI based on the selected subset of FD basis vectors.

In one aspect, a method performed by a wireless device for reporting CSI is provided. The method includes receiving an indication indicating a subset of FD basis vectors among a full set of FD basis vectors per a group of transmission layers from a radio network node. The method also includes computing a CSI corresponding to an enhanced type II port selection codebook using the indicated subset of FD basis vectors. The method also includes reporting the CSI to the radio network node.

In another aspect, the full set of FD basis vectors comprises a set of orthogonal complex vectors having a length that equals N₃.

In another aspect, N₃ is determined by higher layer parameters numberOfPMISubbandsPerCQISubband and csi-ReportingBand.

In another aspect, receiving the indication indicating the subset of FD basis vectors comprises receiving the indication indicating the selected subset of FD basis vectors in a control message.

In another aspect, the control message is a Medium Access Control, MAC, Control Element, CE.

In another aspect, the MAC CE comprises a field configured to indicate the subset of FD basis vectors among the full set of FD basis vectors.

In another aspect, the field in the MAC CE comprises one of: a bitmap of N₃ bits and a bitmap of ┌log₂(N₃)┐ bits.

In another aspect, the MAC CE comprises a plurality of fields each configured to indicate the subset of FD basis vectors among the full set of FD basis vectors for a respective one of a plurality of layers.

In another aspect, each of the plurality of fields in the MAC CE comprises one of: a bitmap of N₃ bits and a bitmap of ┌log₂(N₃)┐ bits.

In another aspect, receiving the indication indicating the subset of FD basis vectors comprises receiving the indication indicating the subset of FD basis vectors in a Downlink Control Information, DCI.

In another aspect, the DCI comprises a field corresponding to a codepoint and configured to indicate the subset of FD basis vectors among the full set of FD basis vectors.

In another aspect, the field in the DCI comprises a CSI-AssociatedReportConfigInfo corresponding to the codepoint.

In another aspect, the method also includes receiving, from the radio network node, a configuration of a CSI-Reference Signal, CSI-RS, resource with a set of CSI-RS ports and an indication that indicates one or more of: one or more non-zero power CSI-RS ports and one or more zero power CSI-RS ports. The method also includes performing channel measurements on the one or more non-zero power CSI-RS ports.

In another aspect, computing the CSI using the indicated subset of FD basis vectors comprises computing the CSI based on all of the indicated subset of FD basis vectors. Reporting the CSI comprises not reporting indices indicating a subset of the indicated subset of FD basis vectors as part of an enhanced type II port selection Precoding Matrix Indicator, PMI, report.

In another aspect, computing the CSI using the indicated subset of FD basis vectors comprises computing the CSI based on a selected subset of the indicated subset of FD basis vectors. Reporting the CSI comprises reporting indices indicating the selected subset of the indicated subset of FD basis vectors as part of an enhanced type II port selection Precoding Matrix Indicator, PMI, report.

In one aspect, a wireless device is provided. The wireless device includes processing circuitry. The processing circuitry is configured to cause the wireless device to receive an indication indicating a subset of FD basis vectors among a full set of FD basis vectors per a group of transmission layers from a radio network node. The processing circuitry is also configured to cause the wireless device to compute a CSI corresponding to an enhanced type II port selection codebook using the indicated FD basis vectors. The processing circuitry is also configured to cause the wireless device to report the CSI to the radio network node.

In another aspect, the processing circuitry is configured to cause the wireless device to perform any of the steps in any of the claims performed by the wireless device.

In one aspect, a method performed by a radio network node for enabling a wireless device to report CSI is provided. The method includes providing an indication indicating a subset of FD basis vectors among a full set of FD basis vectors per a group of transmission layers to the wireless device. The method also includes receiving a CSI from the wireless device.

In another aspect, the method also includes determining the subset of FD basis vectors among the full set of FD basis vectors based on one or more uplink measurements performed on Sounding Reference Signals, SRS, received from the wireless device.

In another aspect, providing the indication indicating the subset of FD basis vectors comprises indicating the selected subset of FD basis vectors in a control message.

In another aspect, the control is a MAC CE.

In another aspect, the MAC CE comprises a field configured to indicate the indicated subset of FD basis vectors among the full set of FD basis vectors.

In another aspect, the field in the MAC CE comprises one of: a bitmap of N₃ bits and a bitmap of ┌log₂(N₃)┐ bits.

In another aspect, the MAC CE comprises a plurality of fields each configured to indicate the indicated subset of FD basis vectors among the full set of FD basis vectors for a respective one of a plurality of layers.

In another aspect, each of the plurality of fields in the MAC CE comprises one of: a bitmap of N₃ bits and a bitmap of ┌log₂(N₃)┐ bits.

In another aspect, providing the indication indicating the subset of FD basis vectors comprises providing the indication indicating the subset of FD basis vectors in a DCI.

In another aspect, the DCI comprises a field corresponding to a codepoint and configured to indicate the subset of FD basis vectors among the full set of FD basis vectors.

In another aspect, the field in the DCI comprises a CSI-AssociatedReportConfigInfo corresponding to the codepoint.

In another aspect, the method also includes providing, to the wireless device, a configuration of a CSI-RS resource with a set of CSI-RS ports and an indication that indicates: one or more non-zero power CSI-RS ports in the CSI-RS resource and/or one or more zero power CSI-RS ports in the CSI-RS resource. The method also includes receiving, from the wireless device, channel measurements performed based on the one or more non-zero power CSI-RS ports.

In another aspect, receiving the CSI comprises one of: receiving the CSI not including indices indicating a subset of the indicated subset of FD basis vectors as part of an enhanced type II port selection PMI report and receiving the CSI including indices indicating a selected subset of the indicated subset of FD basis vectors as part of the enhanced type II port selection PMI report.

In one aspect, a radio network node comprising processing circuitry. The processing circuitry is configured to cause the radio network node to provide an indication indicating a subset of FD basis vectors among a full set of FD basis vectors per a group of transmission layers to the wireless device. The processing circuitry is also configured to cause the radio network node to receive a CSI from the wireless device.

In another aspect, the processing circuitry is further configured to cause the radio network node to perform any of the steps in any of the claims performed by the radio access node.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a schematic diagram providing an exemplary illustration of a New Radio (NR) spatial multiplexing operation;

FIG. 2 is a schematic diagram of an exemplary four-by-four (4×4) array with dual-polarized antenna elements;

FIG. 3 is a schematic diagram of an exemplary Channel State Information (CSI) Reference Signal (CSI-RS REs) for 12 antenna ports;

FIG. 4 is a schematic diagram providing an exemplary illustration of procedure for reciprocity-based Frequency-Division Duplex (FDD) transmission scheme;

FIG. 5 is a schematic diagram providing an exemplary illustration of angle-delay power spectrum of an UL channel with 8 angle bins and 10 delay taps;

FIG. 6 is a schematic diagram providing an exemplary illustration of the number of delay taps being reduced to 3 after a pre-compensating delay for beamformed channels;

FIG. 7 illustrates one example of a cellular communications system in which embodiments of the present disclosure may be implemented;

FIG. 8 is a flowchart of an exemplary method performed by a wireless device for reporting CSI in accordance with embodiments of the present disclosure;

FIG. 9 is a flowchart of an exemplary method performed by a radio network node for enabling a wireless device to report CSI in accordance with embodiments of the present disclosure;

FIG. 10 is a flowchart of an exemplary method performed by a wireless device for reporting CSI based on signaling provided by a radio network node;

FIG. 11 is a flowchart of an exemplary method performed by a radio network node for providing signaling to a wireless device for reporting CSI;

FIG. 12 is a schematic diagram providing an exemplary illustration of a selected subset of Frequency Domain (FD) basis vectors being indicated to a Medium Access Control (MAC) Control Element (CE);

FIG. 13 is a schematic diagram illustrating an exemplary MAC CE configured according to another embodiment of the present disclosure for indicating the selected subset of FD basis vectors to the wireless device;

FIG. 14 is a schematic block diagram of a radio access node according to some embodiments of the present disclosure;

FIG. 15 is a schematic block diagram that illustrates a virtualized embodiment of the radio access node according to some embodiments of the present disclosure;

FIG. 16 is a schematic block diagram of the radio access node according to some other embodiments of the present disclosure;

FIG. 17 is a schematic block diagram of a wireless communication device according to some embodiments of the present disclosure;

FIG. 18 is a schematic block diagram of the wireless communication device according to some other embodiments of the present disclosure;

FIG. 19 is a schematic diagram of a communication system in accordance with an embodiment of the present disclosure;

FIG. 20 is a schematic diagram of the UE, base station, and host computer in accordance with an embodiment of the present disclosure;

FIG. 21 is a flowchart illustrating a method implemented in a communication system in accordance with one embodiment of the present disclosure;

FIG. 22 is a flowchart illustrating a method implemented in a communication system in accordance with one embodiment of the present disclosure;

FIG. 23 is a flowchart illustrating a method implemented in a communication system in accordance with one embodiment of the present disclosure; and

FIG. 24 is a flowchart illustrating a method implemented in a communication system in accordance with one embodiment of the present disclosure.

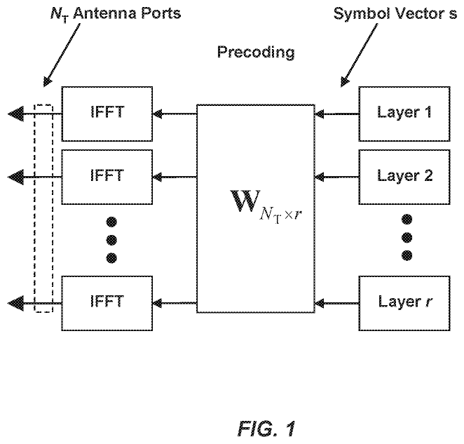

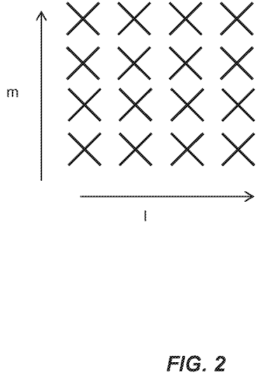

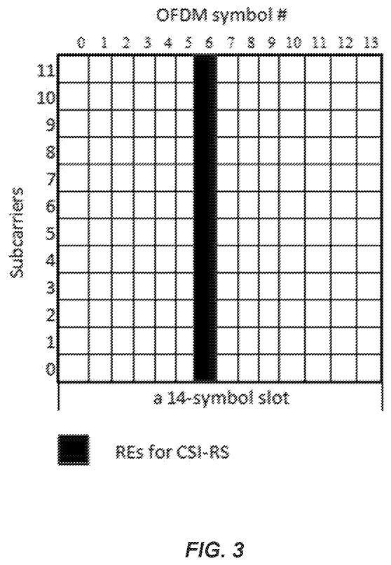

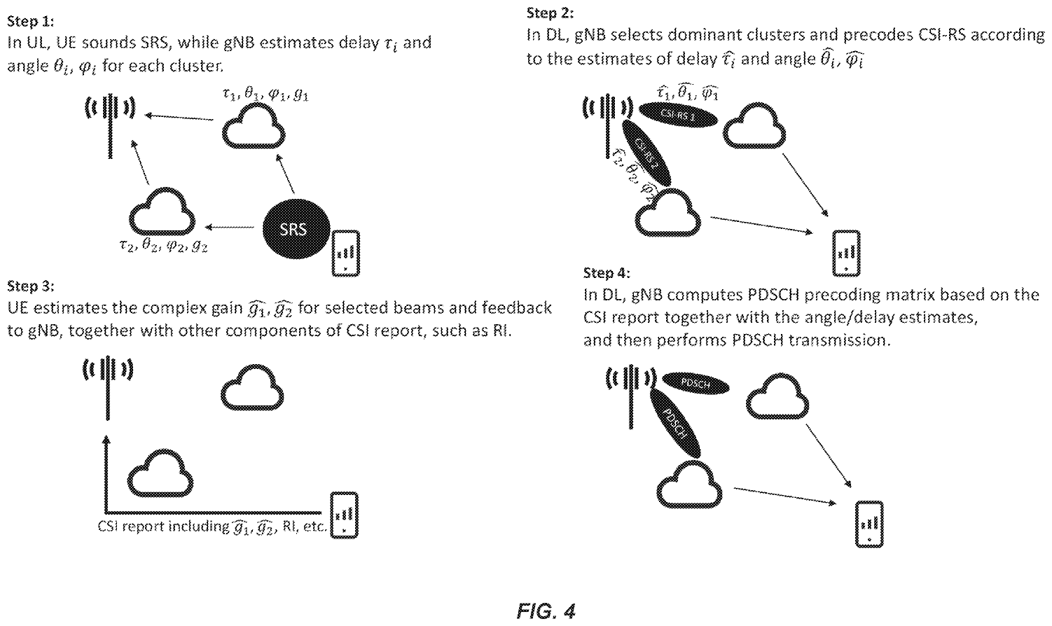

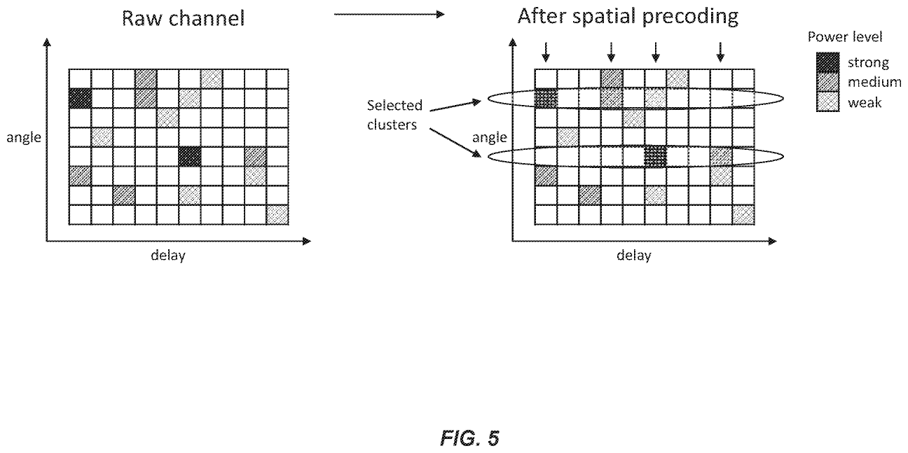

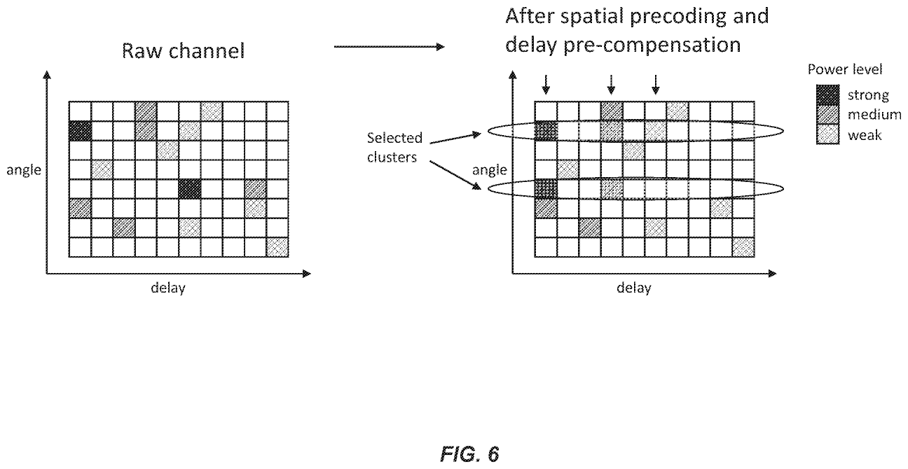

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist a certain challenge(s). The problem of how to signal the selected frequency domain basis vectors and/or spatial domain Channel State Indication (CSI)-Reference Signal (RS) (CSI-RS) ports to the UE from the gNB is not addressed. Furthermore, signaling the selected subset of FD basis vectors and/or CSI-RS ports may increase downlink control overhead. In this regard, it may be desirable to efficiently signal the selected subset of FD basis vectors and/or CSI-RS ports with minimal downlink control overhead while ensuring signaling reliability.

Certain aspects of the present disclosure and their embodiments may provide solutions to the aforementioned or other challenges. In this disclosure, methods for signaling a selected subset of Frequency Domain (FD) basis vectors among a full set of FD basis vectors and/or a selected subset of CSI-RS ports among a full set of CSI-RS ports by gNB to a UE are proposed. Solutions based on both Medium Access Control (MAC) Control Element (CE) signaling and Downlink Control Information (DCI) signaling are proposed to reduce overhead associated with signaling the subset of FD basis vectors and/or CSI-RS ports. Based on the proposed solutions, methods are also proposed where the UE uses all signaled subset of FD basis vectors and/or CSI-RS ports for CSI reporting for an enhanced (i.e., Rel-16) type II port selection codebook, which reduces UE complexity and CSI reporting overhead. Additional methods are also proposed where the UE performs further FD basis vector and/or CSI-RS port sub-selection based on the signaled subset of FD basis vectors instead of the full set of FD basis vectors and/or subset of CSI-RS ports, which reduces UE complexity.

In addition, methods for signaling CSI-RS ports to be measured are also proposed, which can be jointly signaled with the selected subset of FD basis vectors. Specific embodiments disclosed herein include at least the following aspects:
1. A method for signaling to the UE from the network a selected subset of FD basis vectors among a full set N₃ of FD basis vectors, wherein the FD basis vectors are a set of orthogonal complex vectors with length equal to N₃, the method comprising:
   the UE using the indicated FD basis vectors to compute a CSI corresponding to an enhanced type II port selection codebook.
2. The method of 1, where the selected subset of FD basis vectors is signaled via a MAC CE.
3. The method of any of 1 or 2, where each bit in a field of length N₃ in the MAC
   CE indicates whether or not a FD basis vector is selected.
4. The method of any of 1-3, where up to a maximum number of FD basis vectors can be selected and signaled in the MAC CE.
5. The method of 4, where the maximum number of FD basis vectors is determined via one or more higher layer configured parameters.
6. The method of 1, where the selected subset of FD basis vectors is signaled via DCI.
7. The method of any of 1-6, where the UE uses all the indicated FD basis vectors to compute the CSI.
8. The method of 7, where the UE does not feedback report indices i_{1,5} and i_{1,6,l} as part of the enhanced type II port selection PMI report.
9. The method of any of 1-6, where the UE uses a subset of the indicated FD basis vectors to compute the CSI.
10. The method of 9, where the UE may report one or more of the indices i_{1,5} and i_{1,6,l} as part of the enhanced type II port selection PMI report.
11. The method of any of 1-10, where the gNB additionally indicates a subset of non-zero power CSI-RS ports among a set of configured CSI-RS ports to the UE to perform channel measurement.
12. The method of any of 1-10, where the method further comprising that gNB additionally indicates zero power CSI-RS ports among a set of configured CSI-RS ports to the UE.
13. The method of 12, where the UE performs channel measurements on the CSI-RS ports not indicated as zero power CSI-RS ports in the set of CSI-RS ports.

There are, proposed herein, various embodiments which address one or more of the issues disclosed herein.

In one embodiment, a method performed by a wireless device for reporting CSI is provided. The method includes receiving a selected subset of FD basis vectors among a full set (e.g., N₃) of FD basis vectors from a network node (e.g., eNB). The method also includes computing a CSI corresponding to an enhanced (e.g., Rel-16) type II port selection codebook using the selected subset of FD basis vectors. The method also includes reporting the CSI to the network node.

In another embodiment, a method performed by a base station (e.g., eNB) for enabling a wireless device to report the CSI is provided. The method includes indicating a selected subset of FD basis vectors among a full set (e.g., N₃) of FD basis vectors to the wireless device. The method also includes reporting the CSI from the wireless device.

Certain embodiments may provide one or more of the following technical advantages. The main advantages of the proposed solutions are as follows:
Reduced CSI reporting overhead.
Reduced UE complexity.
Reduced signaling overhead for indicating the selected subset of FD basis vectors.

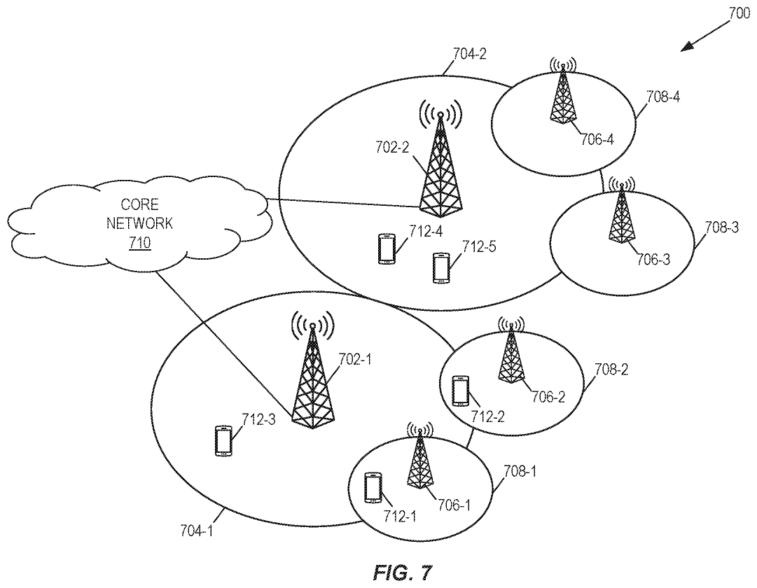

FIG. 7 illustrates one example of a cellular communications system 700 in which embodiments of the present disclosure may be implemented. In the embodiments described herein, the cellular communications system 700 is a 5G system (5GS) including a Next Generation RAN (NG-RAN) and a 5G Core (5GC). In this example, the RAN includes base stations 702-1 and 702-2, which in the 5GS include NR base stations (gNBs) and optionally next generation eNBs (ng-eNBs) (e.g., LTE RAN nodes connected to the 5GC), controlling corresponding (macro) cells 704-1 and 704-2. The base stations 702-1 and 702-2 are generally referred to herein collectively as base stations 702 and individually as base station 702. Likewise, the (macro) cells 704-1 and 704-2 are generally referred to herein collectively as (macro) cells 704 and individually as (macro) cell 704. The RAN may also include a number of low power nodes 706-1 through 706-4 controlling corresponding small cells 708-1 through 708-4. The low power nodes 706-1 through 706-4 can be small base stations (such as pico or femto base stations) or Remote Radio Heads (RRHs), or the like. Notably, while not illustrated, one or more of the small cells 708-1 through 708-4 may alternatively be provided by the base stations 702. The low power nodes 706-1 through 706-4 are generally referred to herein collectively as low power nodes 706 and individually as low power node 706. Likewise, the small cells 708-1 through 708-4 are generally referred to herein collectively as small cells 708 and individually as small cell 708. The cellular communications system 700 also includes a core network 710, which in the 5G System (5GS) is referred to as the 5GC. The base stations 702 (and optionally the low power nodes 706) are connected to the core network 710.

The base stations 702 and the low power nodes 706 provide service to wireless communication devices 712-1 through 712-5 in the corresponding cells 704 and 708. The wireless communication devices 712-1 through 712-5 are generally referred to herein collectively as wireless communication devices 712 and individually as wireless communication device 712. In the following description, the wireless communication devices 712 are oftentimes UEs, but the present disclosure is not limited thereto.

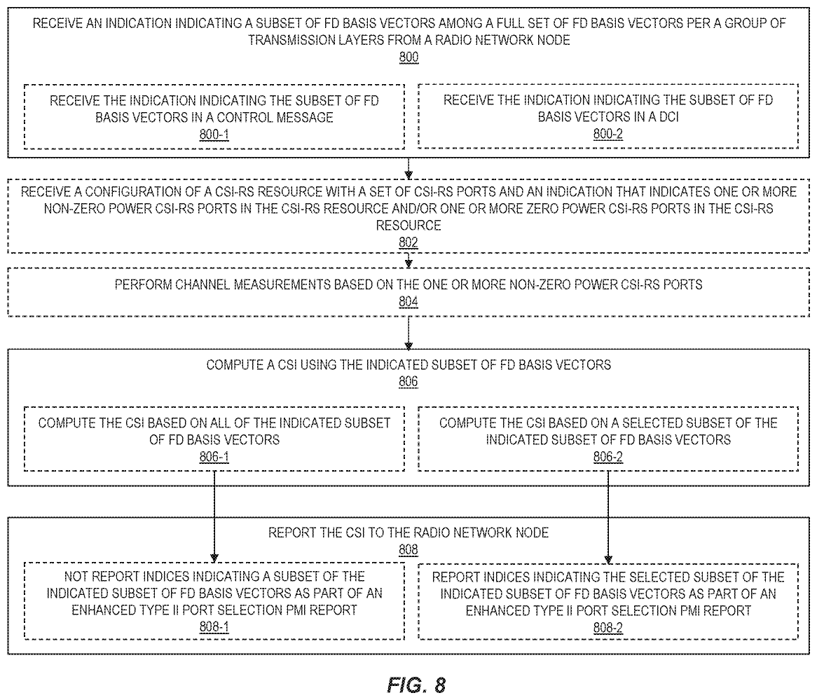

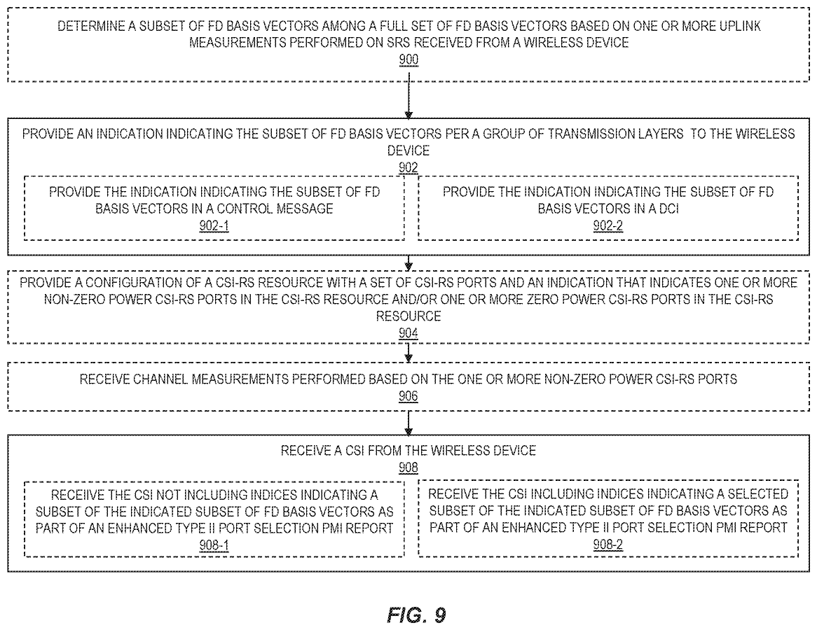

Before discussing specific embodiments of the present disclosure, a method performed by a wireless device (e.g., 712-1, 712-2, 712-3) and a method performed by a radio network node (e.g., 702-1, 702-2, 706-1, 706-2, 706-3, 706-4) for enabling the specific embodiments are first provided with reference to FIGS. 8 and 9.

FIG. 8 is a flowchart of an exemplary method performed by a wireless device for reporting CSI in accordance with embodiments of the present disclosure. The wireless device receives an indication indicating a subset of FD basis vectors among a full set of FD basis vectors per a group of transmission layers from a radio network node (step 800). In one embodiment, the wireless device may receive the indication indicating the subset of FD basis vectors in a control message (step 800-1). In another embodiment, the wireless device may receive the indication indicating the subset of FD basis vectors in a DCI (step 800-2). The wireless device may receive, from the network node, a configuration of a CSI-RS resource with a set of CSI-RS ports and an indication that indicates one or more non-zero power CSI-RS ports in the CSI-RS resource and/or one or more zero power CSI-RS ports in the CSI-RS resource (step 802). Accordingly, the wireless device may perform channel measurements on the one or more non-zero power CSI-RS ports (step 804). The wireless device computes a CSI corresponding to an enhanced type II port selection codebook using the indicated subset of FD basis vectors (step 806). In one embodiment, the wireless device may compute the CSI based on all of the indicated subset of FD basis vectors (step 806-1). In another embodiment, the wireless device may compute the CSI based on a selected subset of the indicated subset of FD basis vectors (step 806-2). The wireless device reports the CSI to the radio network node (step 808). In one embodiment, the wireless device may not report indices indicating a subset of the indicated subset of FD basis vectors as part of an enhanced Type II port selected Precoding Matrix Indicator (PMI) report (step 808-1). In another embodiment, the wireless device may report indices indicating the selected subset of the indicated subset of FD basis vectors as part of an enhanced Type II port selected PMI report (step 808-2).

FIG. 9 is a flowchart of an exemplary method performed by a radio network node for enabling a wireless device to report CSI in accordance with embodiments of the present disclosure. The radio network node may determine a subset of FD basis vectors among the full set of FD basis vectors based on one or more uplink measurements performed on SRS received from a wireless device (step 900). The radio network node provides an indication indicating the subset of FD basis vectors per a group of transmission layers to the wireless device (step 902). In one embodiment, the radio network node may provide the indication indicating the subset of FD basis vectors in a control message (step 902-1). In another embodiment, the radio network node may provide the indication indicating the subset of FD basis vectors in a DCI (step 902-2). The radio network node may provide, to the wireless device, a configuration of a CSI-RS resource with a set of CSI-RS ports and an indication that indicates one or more non-zero power CSI-RS ports in the CSI-RS resource and/or one or more zero power CSI-RS ports in the CSI-RS resource (step 904). Accordingly, the radio network node may receive, from the wireless device, channel measurements performed based on the one or more non-zero power CSI-RS ports (step 906). The radio network node can then receive a CSI from the wireless device (block 908). In one embodiment, the radio network node may receive the CSI not including indices indicating a subset of the indicated subset of FD basis vectors as part of an enhanced Type II port selected PMI report (step 908-1). In another embodiment, the radio network node may receive the CSI including indices indicating a selected subset of the indicated subset of FD basis vectors as part of an enhanced Type II port selected PMI report (step 908-2).

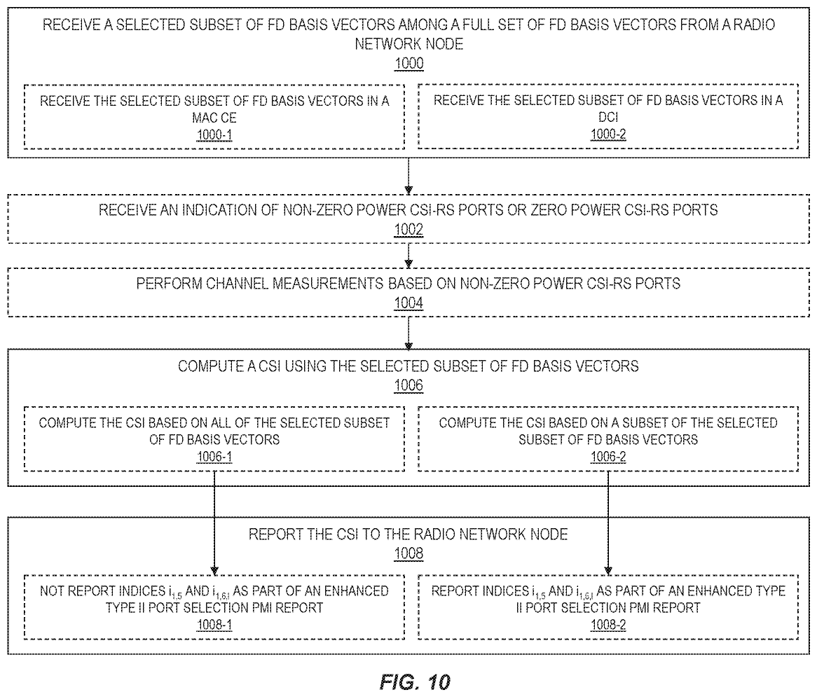

FIG. 10 is a flowchart of an exemplary method performed by a wireless device for reporting CSI. The wireless device receives a selected subset of FD basis vectors among a full set (e.g., N₃) of FD basis vectors from a radio network node (e.g., gNB) (step 1000). In one embodiment, the wireless device may receive the subset of FD basis vectors in a MAC CE (step 1000-1). In another embodiment, the wireless device may receive the subset of FD basis vectors in a DCI (step 1000-2). The wireless device may receive, from the network node, an indication (e.g., via MAC CE or DCI) that indicates one or more non-zero power CSI-RS ports or one or more zero power CSI-RS ports (step 1002) among a set of configured CSI-RS ports. Accordingly, the wireless device may perform channel measurements on the one or more non-zero power CSI-RS ports (step 1004). The wireless device computes a CSI corresponding to an enhanced (e.g., Rel-16) type II port selection codebook using the selected subset of FD basis vectors (step 1006). In one embodiment, the wireless device may compute the CSI based on all of the selected subset of FD basis vectors (step 1006-1). In another embodiment, the wireless device may compute the CSI based on a subset of the selected subset of FD basis vectors (step 1006-2). The wireless device reports the CSI to the radio network node (step 1008). In one embodiment, the wireless device may not report indices i_{1,5} and i_{1,6,j} as part of an enhanced Type II port selected Precoding Matrix Indicator (PMI) report (step 1008-1). In another embodiment, the wireless device may report indices i_{1,5} and i_{1,6,j} as part of an enhanced Type II port selected Precoding Matrix Indicator (PMI) report (step 1008-2).

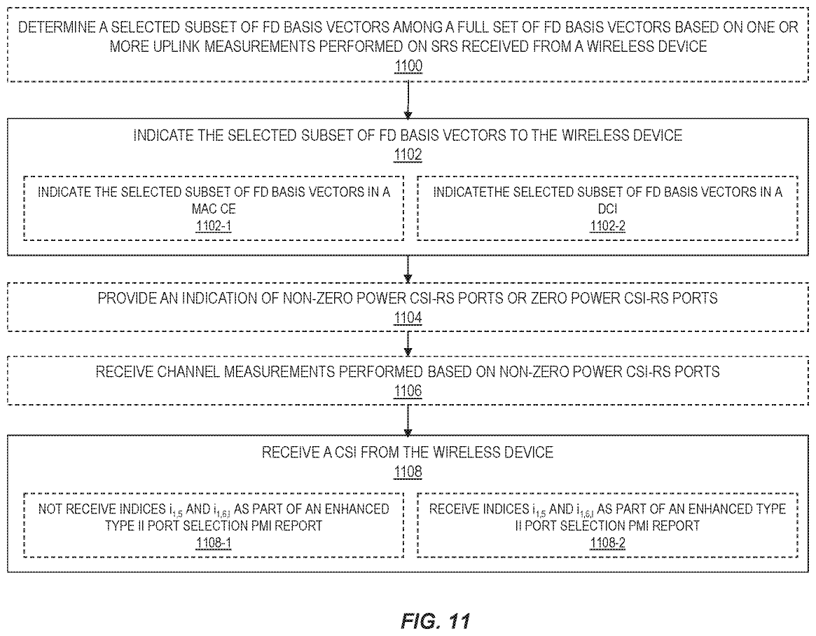

FIG. 11 is a flowchart of an exemplary method performed by a radio network node (e.g., gNB) for enabling a wireless device to report CSI. The radio network node may determine a subset of FD basis vectors among the full set (e.g., N₃) of FD basis vectors based on one or more uplink measurements performed on SRS received from a wireless device (step 1100). The radio network node indicates the selected subset of FD basis vectors to the wireless device (step 1102). In one embodiment, the radio network node may indicate the selected subset of FD basis vectors in a MAC CE (step 1102-1). In another embodiment, the radio network node may indicate the selected subset of FD basis vectors in a DCI (step 1102-2). The radio network node may provide, to the wireless device, an indication (e.g., via MAC CE or DCI) that indicates one or more non-zero power CSI-RS ports or one or more zero power CSI-RS ports (step 1104). Accordingly, the radio network node may receive, from the wireless device, channel measurements performed based on the one or more non-zero power CSI-RS ports (step 1106). The radio network node can then receive a CSI from the wireless device (block 1108). In one embodiment, the radio network node may not receive indices i_{1,5} and i_{1,6,j} as part of an enhanced Type II port selected PMI report (step 1108-1). In another embodiment, the radio network node may receive indices i_{1,5} and i_{1,6,j} as part of an enhanced Type II port selected PMI report (step 1108-2).

Throughout this disclosure, the terms ‘frequency domain basis vectors’ and ‘spatial domain basis vectors/matrices’ are used.

Note that the term ‘frequency domain basis vector’ may not be part of 3GPP standard specifications. Instead, the ‘frequency domain basis vector’ (FD basis vector) may be defined as a set of orthogonal complex vectors (e.g., DFT vector) with length equal to N₃. For instance, in 3GPP specification, the n^{th} frequency domain basis vector, where n={0,1, . . . , N₃−1}, may be defined as follows:

$${f}_{n} = [ \begin{matrix}{e}^{j 2 π \cdot 0 \cdot n / {N}_{3}} \\ {e}^{j 2 π \cdot 1 \cdot n / {N}_{3}} \\ ⋮ \\ {e}^{j 2 π \cdot ( {N}_{3} - 1 ) \cdot n / {N}_{3}}\end{matrix} ]$$

Note that in some cases, the notation f_{n,l} may be used to denote the n^{th} frequency domain basis vector associated with the precoding matrix corresponding to the l^{th} spatial layer.

Similarly, the term ‘spatial domain basis vector/matrix’ (SD basis vector/matrix) may not be part of 3GPP standard specifications. Instead, the ‘spatial domain basis vector/matrix’ may be defined as a set of 2-dimensional orthogonal complex vectors (e.g., 2-dimensional DFT vectors) with length equal to N₁N₂.

### 1—Signaling of Frequency Domain Basis Vectors Via MAC CE

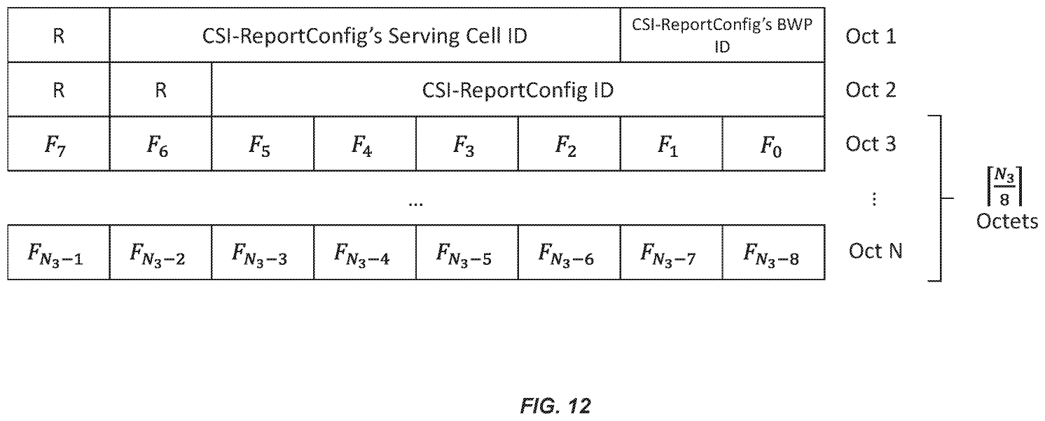

In this embodiment (e.g., steps 1000, 1000-1, 1102, 1102-1), a selected subset of the FD basis vectors among the N₃ FD basis are indicated to the UE by the gNB via a MAC CE. As shown in the example in FIG. 12, a field Fₙ, n∈{0,1, . . . , N₃−1} consisting of a bitmap of N₃ bits (or ┌N₃/8┐octets) are used to indicate the selected subset of FD basis vectors for CSI feedback with a type II port selection codebook. A bit Fₙ set to a value of 1 indicates that the n^{th} FD basis vector fₙ is selected. If the bit Fₙ set to a value of 0, then this means that the n^{th} FD basis vector fₙ is not selected.

As the length of the field Fₙ in the MAC CE is N₃ (which is the number of PMI subbands), the length of the field Fₙ is dependent on the following parameters both of which are higher layer configured (e.g., RRC configured) to the UE:
parameter R configured via higher-layer parameter numberOfPMISubbandsPerCQISubband, and
the number of CQI subbands in csi-ReportMgBand(N_{SB}) which in turn is determined by the subband size configured by higher-layer parameter subbandSize and the total number of PRBs in the bandwidth part.

The above dependence is due to the fact that the number of PMI subbands N₃ is given by the product of R and the number of Channel Quality Indicator (CQI) subbands in the csi-ReportingBand (recall that N₃=N_{SB}×R).

FIG. 12 is an exemplary MAC CE configured according to one embodiment of the present disclosure for indicating the selected subset of FD basis vectors from the network node to the wireless device. In some embodiments, as shown in FIG. 10, the MAC CE for indicating the selected subset of FD basis vectors also contains serving cell ID and/or the Bandwidth Part (BWP) ID corresponding to the CSI reporting configuration in which the type II port-selection codebook based CSI feedback is configured. In addition, the configuration ID of the CSI reporting configuration (i.e., CSI-ReportConfig ID) is also included as part of the MAC CE as shown in FIG. 12.

Including these in the MAC CE is motivated by the need to flexibly indicate a selected subset of FD bases to the UE that is configured with different type II port-selection codebook based CSI feedback in different CSI reporting configurations in the same or different BWPs in different serving cells configured to the UE.

Although each selected FD basis vector is indicated via a single bit in a bitmap in FIG. 12, the selected FD basis vectors may also be indicated in other forms as well. For instance, in another example MAC CE each selected FD basis vector may be indicated by ┌log₂(N₃)┐ bits in the MAC CE. In this case, to select M FD basis vectors, M×┌log₂(N₃)┐ bits may need to be included in the MAC CE. In another example, one or more combinatorial indicator(s) may be used in the MAC CE to indicate the one or more selected FD basis vectors to the UE.

### 1.1—Embodiment with Number of Selected FD Bases in MAC CE being Determined by Higher Layer Configured Parameters

In one embodiment, the number of FD basis vectors selected and indicated via the MAC CE is given by Mₘₐₓ=┌p_{v,max}×N₃/R┐ where R is given by higher layer parameter numberOfPMISubbandsPerCQISubband, and N₃ is the number of PMI subbands. The parameter p_{v,max} is determined via the higher layer parameter paramCombination-r16as the maximum pᵥ value among pᵥ,v∈{1,2} and pᵥ, v∈{3,4}.

TABLE 2
Codebook parameter configuration for pᵥ

| | |
|---|---|
| paramCombination- | p_{υ} |

| r16 | L | υ ∈ {1, 2} | υ ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |

In the above table, when paramCombination-r16 is configured to be 4, p_{v,max} is given by ¼ as the pᵥ value corresponding to v∈{1,2} is higher than the pᵥ value corresponding to v∈{3,4}. Once the MAC CE indicates a selection of Mₘₐₓ FD basis vectors to the UE, the UE can perform the following procedures:
If the UE indicates an RI equal to either 1 or 2, then the UE will use all Mₘₐₓ FD basis vectors indicated in the MAC CE for type II port selection CSI feedback. Hence, in this case, the UE does not have to perform FD basis vector selection, and the UE does not have to feedback the selected FD basis vectors to the gNB. This means the UE does not have to report the index i_{1,5} (which is reported as part of the PMI in the NR Rel-16 enhanced type II port selection codebook-based CSI report for N₃>19). Similarly, index i_{1,6,l} (which indicates the selected subset of FD basis vectors to the gNB in NR Rel-16 type II port selection codebook-based CSI report) does not need to be reported by the UE to the gNB as part of the PMI report. This amounts to notable CSI report overhead savings compared to the Rel-16 type II enhanced CSI reporting.
If the UE indicates an RI equal to either 3 or 4, then the UE will use a subset of the Mₘₐₓ FD basis vectors indicated in the MAC CE for type II port selection CSI feedback. Hence, in this case, the UE performs FD basis selection from only among the Mₘₐₓ FD basis vectors indicated in the MAC CE instead of the total number N₃ of frequency-domain bases which reduces the complexity at the UE. Note that in this case, the UE may report one or more of the indices i_{1,5} and i_{1,6,l} as part of the rel-16 type II port selection PMI report.

In an alternative embodiment, if the UE indicates a Rank Indicator (RI) equal to either 1 or 2, then the UE will use a subset of Mₘₐₓ FD basis vectors indicated in the MAC CE for type II port selection CSI feedback. Hence, in this alternative embodiment, the UE performs FD basis vector selection from only among the Mₘₐₓ FD basis vectors indicated in the MAC CE instead of the total number N₃ of frequency-domain bases which reduces the complexity at the UE. Note that in this case, the UE may report one or more of the indices i_{1,5} and -1,6,l as part of the Rel-16 type II port selection PMI report.

In some embodiments, when a subset of FD basis vectors among the Mₘₐₓ FD basis vectors indicated in the MAC CE are selected by the UE, the combinatorial coefficient table C(x,y) in Table 5.2.2.2.5-4 of 3GPP TS 38.214 is used when identifying the one or more i_{1,6,l} which are to be reported by the UE as part of the Rel-16 type II port selection PMI report.

### 1.2—Embodiment with Varying Number of Selected FD Basis Vectors Indicated in MAC CE

In this embodiment (e.g., step 1100), the number of FD basis vectors selected M_{flex} and indicated via the MAC CE is flexibly selected by the gNB based on measurements on the uplink channels without being restricted by higher layer parameters such as pᵥ, N₃, and R.

In some cases, the maximum number of FD basis vectors that can be selected can be defined via higher layer parameters. For instance, the maximum number of FD basis vectors selected can be given by Mₘₐₓ=┌p_{v,max}×N₃/R┐ where R is given by higher layer parameter numberOfPMISubbandsPerCQISubband, and N₃ is the number of PMI subbands. The parameter p_{v,max} is determined via the higher layer parameter paramCombination-r16 as the maximum pᵥ value among pᵥ, v∈{1,2} and pᵥ, v∈{3,4}. Hence, in this example embodiment, the number of selected FD basis vectors M_{flex}=1, 2, . . . , Mₘₐₓ.

In one variant of this embodiment, the UE will use all M_{flex} FD basis vectors indicated in the MAC CE for type II port selection CSI feedback (e.g., step 806-1). Hence, in this case, the UE does not have to perform FD basis vector selection, and the UE does not have to feedback the selected FD basis vectors to the gNB. This is beneficial in reducing the UE complexity. Furthermore, there are overhead savings as well as the UE does not have to report indices i_{1,5} and i_{1,6,l} as part of the rel-16 type II port selection PMI report (e.g., steps 1008-1, 1108-1).

In another variant of this embodiment, the UE will use a subset of M_{flex} FD basis vectors indicated in the MAC CE for type II port selection CSI feedback (e.g., step 1006-2). Hence, in this alternative embodiment, the UE performs FD basis vector selection from only among the M_{flex} FD basis vectors indicated in the MAC CE instead of the total number N₃ of FD basis vectors which reduces the complexity at the UE. Note that in this case, the UE may report one or more of the indices i_{1,5} and i_{1,6,l} as part of the Rel-16 type II port selection PMI report (e.g., steps 1008-2, 1108-2).

### 1.3—Embodiment with Different Number of Selected FD Basis Vectors Indicated for Different Number of Layers

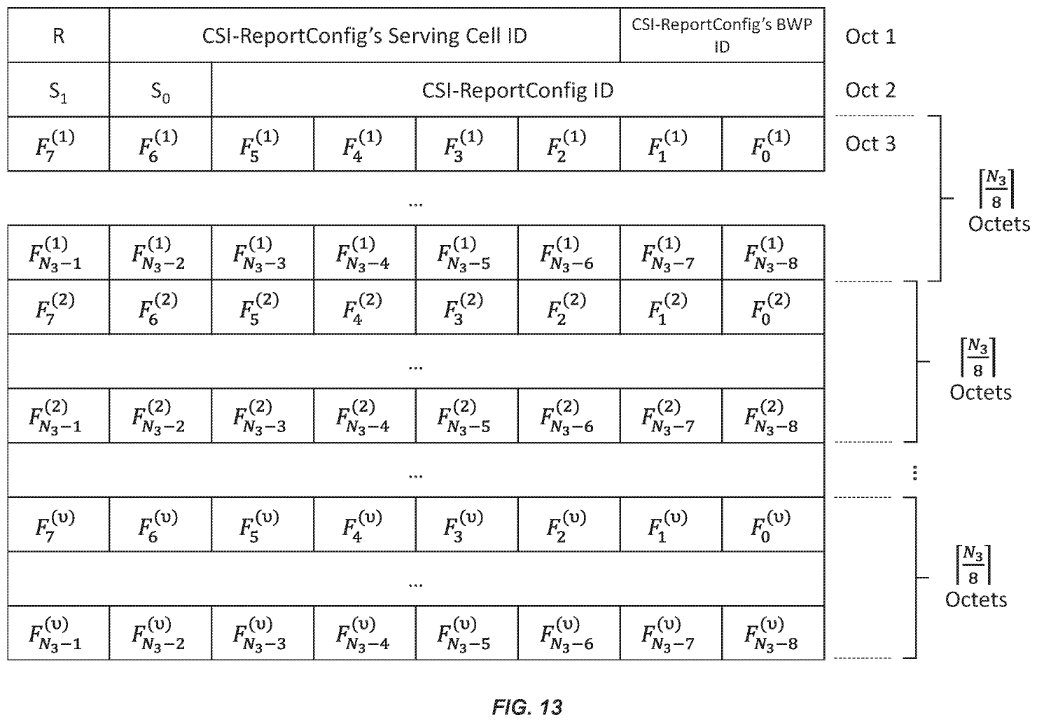

In this embodiment, the number of selected FD basis vectors may be indicated in a MAC CE per layer or per a group of layers. FIG. 13 is an exemplary MAC CE configured according to another embodiment of the present disclosure for indicating the selected subset of FD basis vectors from the network node to the wireless device. As shown in FIG. 11, for each layer l(l=1, . . . , v), a field Fₙ^{(l)}, n∈{0, 1 . . . , N₃-1} consisting of a bitmap of bits (or ┌N₃/8┐ octets) are used to indicate the selected subset of FD basis vectors for CSI feedback with a type II port selection codebook with l layers. A bit Fₙ^{(l)} set to a value of 1 indicates that the n^{th} FD basis vector f_{n,l} associated with the precoding matrix corresponding to the l^{th} spatial layer is selected. If the bit Fₙ^{(l)} set to a value of 0, then this means that the n^{th} FD basis vector f_{n,l} is not selected.

Although the example in FIG. 13 shows one field Fₙ^{(l)} associated with each layer l, this embodiment can also be generalized for a case where one field in MAC CE is associated with a group of layers. For instance, one such field can be associated with layers l=1 or 2, while another field can be associated with layers l=3 or 4.

In some embodiments, the maximum number of FD basis vectors that can be selected can be defined via higher layer parameters for each layer or per group of layers.

### 2—Signaling of Frequency Domain Basis Vectors Via DCI

Another possibility to indicate the selected FD basis vectors via DCI (e.g., steps 1000, 1000-1, 1102, 1102-2).

In one embodiment, lists of different selected FD basis vectors can be preconfigured by higher layers (e.g., via RRC), and a field in DCI could select and indicate one of the preconfigured lists to the UE. For example, one such list can be configured per CSI-AssociatedReportConfigInfo in the CSI-AperiodicTriggerStateList information element as shown below. In the example below, the FDBasisVectorld can be in the range {0,1, . . . , N₃−1}. With this example embodiment, different selected FD basis vectors lists can be triggered via different codepoints in the CSI request field. That is, codepoint 1 in the CSI request field can trigger a first CSI-AssociatedReportConfigInfo containing a first list of selected FD basis vectors, and codepoint 2 in the CSI request field can trigger a second CSI-AssociatedReportConfigInfo containing a second list of selected FD basis vectors.

CSI-AperiodicTriggerStateList information element

-- ASN1START
-- TAG-CSI-APERIODICTRIGGERSTATELIST-START

| | |
|---|---|
| CSI-AperiodicTriggerStateList ::= | SEQUENCE (SIZE |

(1..maxNrOfCSI-AperiodicTriggers)) OF CSI-AperiodicTriggerState

| | |
|---|---|
| CSI-AperiodicTriggerState ::= | SEQUENCE { |
| associatedReportConfigInfoList | SEQUENCE |

(SIZE(1..maxNrofReportConfigPerAperiodicTrigger)) OF CSI-
AssociatedReportConfigInfo,
...
}
CSI-AssociatedReportConfigInfo ::= SEQUENCE {

| | |
|---|---|
| reportConfigId | CSI-ReportConfigId, |
| resourcesForChannel | CHOICE { |
| nzp-CSI-RS | SEQUENCE { |
| resourceSet | INTEGER |

(1..maxNrofNZP-CSI-RS-ResourceSetsPerConfig),

| | |
|---|---|
| qcl-info | SEQUENCE |

(SIZE(1..maxNrofAP-CSI-RS-ResourcesPerSet)) OF TCI-StateId

OPTIONAL -- Cond

Aperiodic
},

| | |
|---|---|
| csi-SSB-ResourceSet | INTEGER |

(1..maxNrofCSI-SSB-ResourceSetsPerConfig)
},

| | |
|---|---|
| csi-IM-ResourcesForInterference | INTEGER(1..maxNrofCSI-IM- |

ResourceSetsPerConfig)

OPTIONAL, -- Cond

CSI-IM-ForInterference
nzp-CSI-RS-ResourcesForInterference INTEGER
(1..maxNrofNZP-CSI-RS-ResourceSetsPerConfig)

OPTIONAL, -- Cond

```
NZP-CSI-RS-ForInterference
  associatedFDBasisVectorsList SEQUENCE
(SIZE(1..maxNrofFDBasisVectorsPerAperiodicTrigger)) OF
FDBasisVectorId
OPTIONAL
  ...
}
-- TAG-CSI-APERIODICTRIGGERSTATELIST-STOP
-- ASN1STOP
```

### 3—Signaling of Spatial Domain basis vectors dynamically in DCI or MAC CE

This embodiment (e.g., steps 1002, 1004, 1106, 1108) addresses the issue where the number of strong clusters varies over time in the channel between the gNB and the UE. This means that the needed number of CSI-RS ports will also vary. Unless this is addressed, the UE needs to be configured with a CSI-RS resource containing an upper bound on the number of CSI-RS ports anticipated to be needed. Alternatively, this embodiment can be used when an N port CSI-RS resource configuration is shared among multiple UEs. For a given UE, only a subset of L ports is of interest, as the other N-L ports are intended for other UEs.

To have flexibility in the value of N, a UE may be configured with multiple NZP CSI-RS resources with different number of CSI-RS ports N, and the suitable number of ports for a given UE, i.e., NZP CSI-RS resource is selected based on UL measurement. For example, if it is determined that there are L=6 dominant directions from a UE according to certain criteria based on UL measurement, then a NZP CSI-RS resource with N=8 (N>=L) ports can be selected and triggered for CSI feedback by the UE, where zero power is transmitted in two of the 8 ports. This minimizes the overhead since the number of used ports matches more closely the number of needed ports at a given point in time.

To further reduce UE processing complexity, the N-L ports which the gNB decide to transmit with zero power (since L ports is sufficient) or the L ports with non-zero power may be also signaled to the UE. In this case, the UE would ignore the N-L ports with zero power and only measure and calculate CSI based on the L active (i.e., non-zero power) ports.

The UE may further down select L1 ports (or beams) out of the L ports (or beams) and report back the L1 selected ports and the corresponding CSI coefficients. Overhead in this case with dynamic signaling of non-zero ports further reduced considering that only L ports, not N ports, are used in the actual CSI measurement and the port index range is from 0 to L−1 instead of 0 to N−1.

In one embodiment, the ports with non-zero power are always mapped to the first L CSI-RS ports in the N-port NZP CSI-RS resource. Thus, the value of either L or N-L is signaled to the UE. Since the NZP CSI-RS resource can always be selected such that L>N-L, signaling N-L can have a smaller overhead. Considering N=4,8,12,16,24,32 is supported in NR for Type II port selection codebook, a maximum of 3 bits is enough in DCI to signal N-L inactive ports.

The signaling can be done in either DCI or MAC CE. In the case of MAC CE, alternatively a bitmap of P_{CSI-RS}/2 bits may be used, where each bit is associated with a CSI-RS port in each of the two polarizations. A pair of non-zero power CSI-RS ports in different polarizations can be indicated by setting the corresponding bit to “1” in the P_{CSI-RS}/2 bits. This would provide more flexibility in case the N CSI-RS ports may be shared by multiple UEs and different UEs may use different CSI-RS ports.

In some embodiments, the signaling of the CSI-RS ports with non-zero power is equivalent to signaling of Spatial Domain basis vectors.

In some embodiments, the signaling of non-zero power CSI-RS ports (or zero power CSI-RS ports) can be done jointly with signaling of selected FD basis vectors (as covered in the embodiments in the section “Signaling of Frequency Domain basis vectors via MAC CE” above) in the same MAC CE. That is different fields or bitmaps in the MAC CE may indicate the non-zero power CSI-RS ports (or zero power CSI-RS ports) and the selected FD basis vectors. In another embodiment, the presence of one of these fields may be optional in a MAC CE and is controlled by a bit in the MAC CE. For instance, the indication of non-zero power CSI-RS ports (or zero power CSI-RS ports) can be optional in the MAC CE, and a bit or flag in the MAC CE can indicate whether the field that indicates non-zero power CSI-RS ports (or zero power CSI-RS ports) is present in the MAC CE or not.

### 4—Common Sub-Embodiments

### 4.1—Enabling the Feature

In some embodiments, a parameter enableFDbasisSelection is configured to the UE by the gNB such that the parameter enables the use of the corresponding MAC CE for selecting the FD basis vectors. For example, this parameter can be included in IE ServingceIIConfig as shown below:

enableFDbasisSelection ENUMERATED {enabled}

OPTIONAL, —Need R

enableFDbasisSelection

When this parameter is present, the Rel-17 feature of MAC CE based FD basis vector selection is enabled. The network only configures this parameter when the UE is configured with codebookType set as typeII-PortSelection.

In an alternative embodiment, the enabling parameter is for the whole feature of selecting FD basis vectors. This may include the MAC CE example in the first embodiment of this subsection, or RRC only option, which means UE is given in RRC signaling the FDbasis, or DCI only option as in the section “Signaling of Frequency Domain basis vectors via DCI” above.

In an alternative embodiment, the parameter is for signaling spatial domain basis selection (or indicating non-zero power or zero power CSI-RS ports) similar to what is described above for FD basis vector selection. In an alternative embodiment, the parameter is for enabling both FD and SD basis vector selection.

In yet another embodiment, the parameter can enable either FDbasis, SDbasis or both.

enableFDSDbasisSelection ENUMERATED {fdBasis, sdBasis, both}

OPTIONAL, —Need R

enableFDbasisSelection

When this parameter is set to fdbasis, the Rel-17 feature of FD basis vector selection is enabled. When this parameter is set to sdbasis, the Rel-17 feature of SD basis vector selection is enabled. When this parameter is set to both, both the Rel-17 feature of FD basis and SD basis vector selection is enabled. The network only configures this parameter when the UE is configured with codebookType set as Type2.

In another embodiment, any of the above parameters may be set as enabled if UE has indicated a corresponding capability.

### 4.2—Timing when MAC CE is Assumed Valid at UE

According to this embodiment, the UE applies the FD/SD basis vectors indicated in the MAC CE in slot X after the UE sends ACK for receiving the MAC CE. The value X may be RRC coded or it may be fixed in the specification.

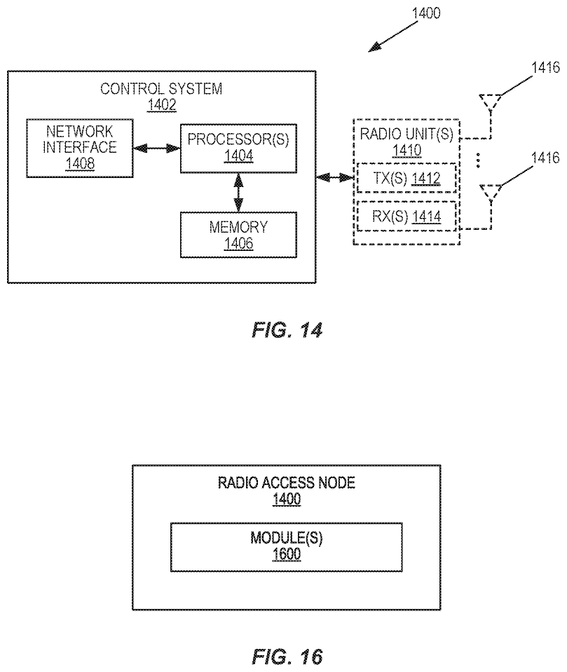

FIG. 14 is a schematic block diagram of a radio access node 1400 according to some embodiments of the present disclosure. Optional features are represented by dashed boxes. The radio access node 1400 may be, for example, a base station 702 or 706 or a network node that implements all or part of the functionality of the base station 702 or gNB described herein. As illustrated, the radio access node 1400 includes a control system 1402 that includes one or more processors 1404 (e.g., Central Processing Units (CPUs), Application Specific Integrated Circuits (ASICs), Field Programmable Gate Arrays (FPGAs), and/or the like), memory 1406, and a network interface 1408. The one or more processors 1404 are also referred to herein as processing circuitry. In addition, the radio access node 1400 may include one or more radio units 1410 that each includes one or more transmitters 1412 and one or more receivers 1414 coupled to one or more antennas 1416. The radio units 1410 may be referred to or be part of radio interface circuitry. In some embodiments, the radio unit(s) 1410 is external to the control system 1402 and connected to the control system 1402 via, e.g., a wired connection (e.g., an optical cable). However, in some other embodiments, the radio unit(s) 1410 and potentially the antenna(s) 1416 are integrated together with the control system 1402. The one or more processors 1404 operate to provide one or more functions of a radio access node 1400 as described herein. In some embodiments, the function(s) are implemented in software that is stored, e.g., in the memory 1406 and executed by the one or more processors 1404.

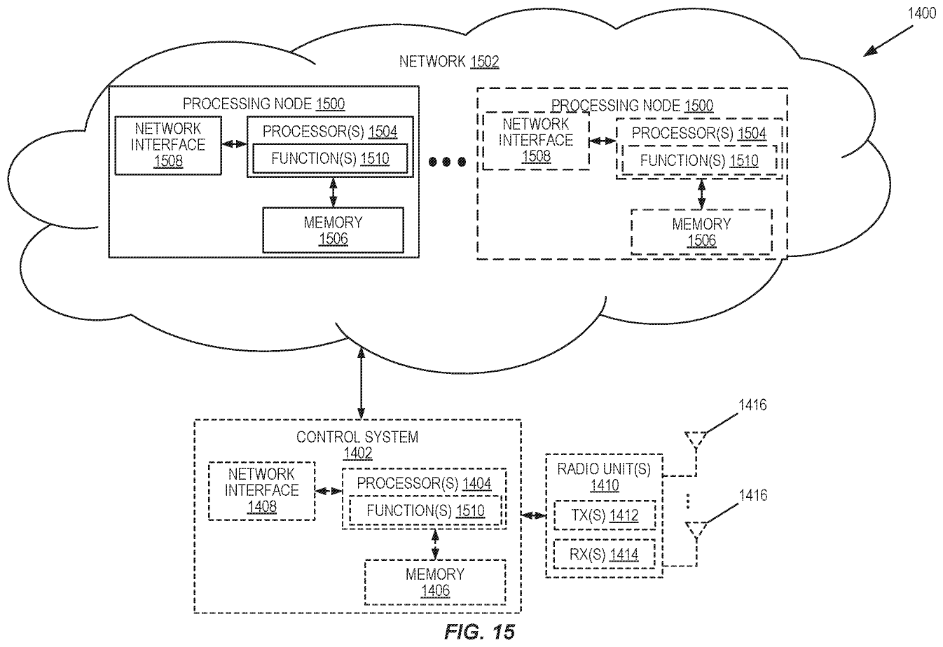

FIG. 15 is a schematic block diagram that illustrates a virtualized embodiment of the radio access node 1400 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1400 in which at least a portion of the functionality of the radio access node 1400 is implemented as a virtual component(s) (e.g., via a virtual machine(s) executing on a physical processing node(s) in a network(s)). As illustrated, in this example, the radio access node 1400 may include the control system 1402 and/or the one or more radio units 1410, as described above. The control system 1402 may be connected to the radio unit(s) 1410 via, for example, an optical cable or the like. The radio access node 1400 includes one or more processing nodes 1500 coupled to or included as part of a network(s) 1502. If present, the control system 1402 or the radio unit(s) is connected to the processing node(s) 1500 via the network 1502. Each processing node 1500 includes one or more processors 1504 (e.g., CPUs, ASICs, FPGAs, and/or the like), memory 1506, and a network interface 1508.

In this example, functions 1510 of the radio access node 1400 described herein are implemented at the one or more processing nodes 1500 or distributed across the one or more processing nodes 1500 and the control system 1402 and/or the radio unit(s) 1410 in any desired manner. In some particular embodiments, some or all of the functions 1510 of the radio access node 1400 described herein are implemented as virtual components executed by one or more virtual machines implemented in a virtual environment(s) hosted by the processing node(s) 1500. As will be appreciated by one of ordinary skill in the art, additional signaling or communication between the processing node(s) 1500 and the control system 1402 is used in order to carry out at least some of the desired functions 1510. Notably, in some embodiments, the control system 1402 may not be included, in which case the radio unit(s) 1410 communicates directly with the processing node(s) 1500 via an appropriate network interface(s).

In some embodiments, a computer program including instructions which, when executed by at least one processor, causes the at least one processor to carry out the functionality of radio access node 1400 or a node (e.g., a processing node 1500) implementing one or more of the functions 1510 of the radio access node 1400 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 16 is a schematic block diagram of the radio access node 1400 according to some other embodiments of the present disclosure. The radio access node 1400 includes one or more modules 1600, each of which is implemented in software. The module(s) 1600 provide the functionality of the radio access node 1400 described herein. This discussion is equally applicable to the processing node 1500 of FIG. 15 where the modules 1600 may be implemented at one of the processing nodes 1500 or distributed across multiple processing nodes 1500 and/or distributed across the processing node(s) 1500 and the control system 1402.

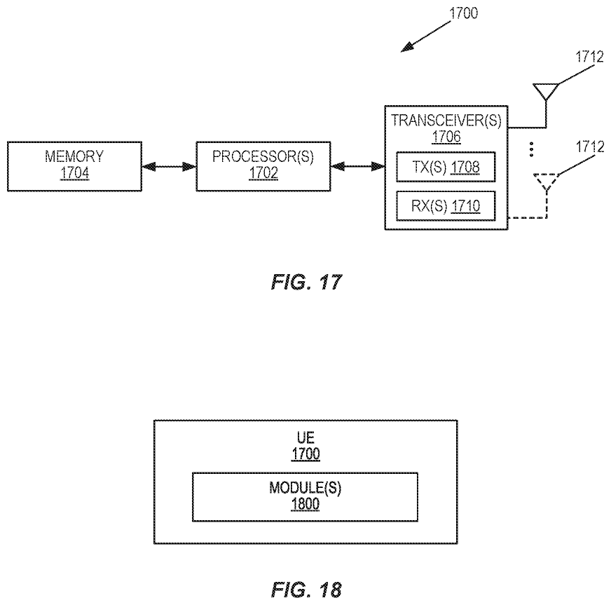

FIG. 17 is a schematic block diagram of a wireless communication device 1700 according to some embodiments of the present disclosure. As illustrated, the wireless communication device 1700 includes one or more processors 1702 (e.g., CPUs, ASICs, FPGAs, and/or the like), memory 1704, and one or more transceivers 1706 each including one or more transmitters 1708 and one or more receivers 1710 coupled to one or more antennas 1712. The transceiver(s) 1706 includes radio-front end circuitry connected to the antenna(s) 1712 that is configured to condition signals communicated between the antenna(s) 1712 and the processor(s) 1702, as will be appreciated by on of ordinary skill in the art. The processors 1702 are also referred to herein as processing circuitry. The transceivers 1706 are also referred to herein as radio circuitry. In some embodiments, the functionality of the wireless communication device 1700 described above may be fully or partially implemented in software that is, e.g., stored in the memory 1704 and executed by the processor(s) 1702. Note that the wireless communication device 1700 may include additional components not illustrated in FIG. 17 such as, e.g., one or more user interface components (e.g., an input/output interface including a display, buttons, a touch screen, a microphone, a speaker(s), and/or the like and/or any other components for allowing input of information into the wireless communication device 1700 and/or allowing output of information from the wireless communication device 1700), a power supply (e.g., a battery and associated power circuitry), etc.

In some embodiments, a computer program including instructions which, when executed by at least one processor, causes the at least one processor to carry out the functionality of the wireless communication device 1700 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 18 is a schematic block diagram of the wireless communication device 1700 according to some other embodiments of the present disclosure. The wireless communication device 1700 includes one or more modules 1800, each of which is implemented in software. The module(s) 1800 provide the functionality of the wireless communication device 1700 described herein.

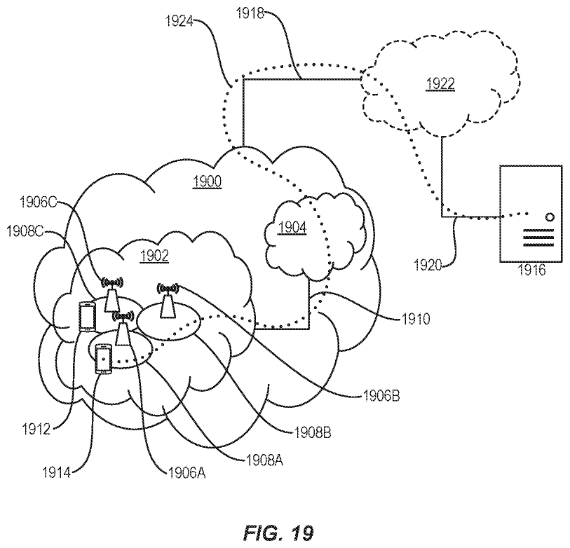

With reference to FIG. 19, in accordance with an embodiment, a communication system includes a telecommunication network 1900, such as a 3GPP-type cellular network, which comprises an access network 1902, such as a RAN, and a core network 1904. The access network 1902 comprises a plurality of base stations 1906A, 1906B, 1906C, such as Node Bs, eNBs, gNBs, or other types of wireless Access Points (APs), each defining a corresponding coverage area 1908A, 1908B, 1908C. Each base station 1906A, 1906B, 1906C is connectable to the core network 1904 over a wired or wireless connection 1910. A first UE 1912 located in coverage area 1908C is configured to wirelessly connect to, or be paged by, the corresponding base station 1906C. A second UE 1914 in coverage area 1908A is wirelessly connectable to the corresponding base station 1906A. While a plurality of UEs 1912, 1914 are illustrated in this example, the disclosed embodiments are equally applicable to a situation where a sole UE is in the coverage area or where a sole UE is connecting to the corresponding base station 1906.

The telecommunication network 1900 is itself connected to a host computer 1916, which may be embodied in the hardware and/or software of a standalone server, a cloud-implemented server, a distributed server, or as processing resources in a server farm. The host computer 1916 may be under the ownership or control of a service provider, or may be operated by the service provider or on behalf of the service provider. Connections 1918 and 1920 between the telecommunication network 1900 and the host computer 1916 may extend directly from the core network 1904 to the host computer 1916 or may go via an optional intermediate network 1922. The intermediate network 1922 may be one of, or a combination of more than one of, a public, private, or hosted network; the intermediate network 1922, if any, may be a backbone network or the Internet; in particular, the intermediate network 1922 may comprise two or more sub-networks (not shown).

The communication system of FIG. 19 as a whole enables connectivity between the connected UEs 1912, 1914 and the host computer 1916. The connectivity may be described as an Over-the-Top (OTT) connection 1924. The host computer 1916 and the connected UEs 1912, 1914 are configured to communicate data and/or signaling via the OTT connection 1924, using the access network 1902, the core network 1904, any intermediate network 1922, and possible further infrastructure (not shown) as intermediaries. The OTT connection 1924 may be transparent in the sense that the participating communication devices through which the OTT connection 1924 passes are unaware of routing of uplink and downlink communications. For example, the base station 1906 may not or need not be informed about the past routing of an incoming downlink communication with data originating from the host computer 1916 to be forwarded (e.g., handed over) to a connected UE 1912. Similarly, the base station 1906 need not be aware of the future routing of an outgoing uplink communication originating from the UE 1912 towards the host computer 1916.

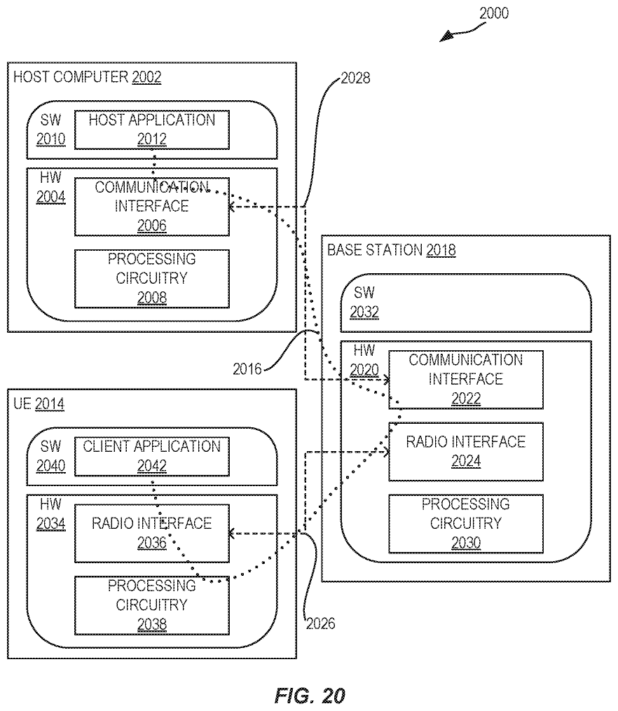

Example implementations, in accordance with an embodiment, of the UE, base station, and host computer discussed in the preceding paragraphs will now be described with reference to FIG. 20. In a communication system 2000, a host computer 2002 comprises hardware 2004 including a communication interface 2006 configured to set up and maintain a wired or wireless connection with an interface of a different communication device of the communication system 2000. The host computer 2002 further comprises processing circuitry 2008, which may have storage and/or processing capabilities. In particular, the processing circuitry 2008 may comprise one or more programmable processors, ASICs, FPGAs, or combinations of these (not shown) adapted to execute instructions. The host computer 2002 further comprises software 2010, which is stored in or accessible by the host computer 2002 and executable by the processing circuitry 2008. The software 2010 includes a host application 2012. The host application 2012 may be operable to provide a service to a remote user, such as a UE 2014 connecting via an OTT connection 2016 terminating at the UE 2014 and the host computer 2002. In providing the service to the remote user, the host application 2012 may provide user data which is transmitted using the OTT connection 2016.

The communication system 2000 further includes a base station 2018 provided in a telecommunication system and comprising hardware 2020 enabling it to communicate with the host computer 2002 and with the UE 2014. The hardware 2020 may include a communication interface 2022 for setting up and maintaining a wired or wireless connection with an interface of a different communication device of the communication system 2000, as well as a radio interface 2024 for setting up and maintaining at least a wireless connection 2026 with the UE 2014 located in a coverage area (not shown in FIG. 20) served by the base station 2018. The communication interface 2022 may be configured to facilitate a connection 2028 to the host computer 2002. The connection 2028 may be direct or it may pass through a core network (not shown in FIG. 20) of the telecommunication system and/or through one or more intermediate networks outside the telecommunication system. In the embodiment shown, the hardware 2020 of the base station 2018 further includes processing circuitry 2030, which may comprise one or more programmable processors, ASICs, FPGAs, or combinations of these (not shown) adapted to execute instructions. The base station 2018 further has software 2032 stored internally or accessible via an external connection.

The communication system 2000 further includes the UE 2014 already referred to. The UE's 2014 hardware 2034 may include a radio interface 2036 configured to set up and maintain a wireless connection 2026 with a base station serving a coverage area in which the UE 2014 is currently located. The hardware 2034 of the UE 2014 further includes processing circuitry 2038, which may comprise one or more programmable processors, ASICs, FPGAs, or combinations of these (not shown) adapted to execute instructions. The UE 2014 further comprises software 2040, which is stored in or accessible by the UE 2014 and executable by the processing circuitry 2038. The software 2040 includes a client application 2042. The client application 2042 may be operable to provide a service to a human or non-human user via the UE 2014, with the support of the host computer 2002. In the host computer 2002, the executing host application 2012 may communicate with the executing client application 2042 via the OTT connection 2016 terminating at the UE 2014 and the host computer 2002. In providing the service to the user, the client application 2042 may receive request data from the host application 2012 and provide user data in response to the request data. The OTT connection 2016 may transfer both the request data and the user data. The client application 2042 may interact with the user to generate the user data that it provides.

It is noted that the host computer 2002, the base station 2018, and the UE 2014 illustrated in FIG. 20 may be similar or identical to the host computer 1916, one of the base stations 1906A, 1906B, 1906C, and one of the UEs 1912, 1914 of FIG. 19, respectively. This is to say, the inner workings of these entities may be as shown in FIG. 20 and independently, the surrounding network topology may be that of FIG. 19.

In FIG. 20, the OTT connection 2016 has been drawn abstractly to illustrate the communication between the host computer 2002 and the UE 2014 via the base station 2018 without explicit reference to any intermediary devices and the precise routing of messages via these devices. The network infrastructure may determine the routing, which may be configured to hide from the UE 2014 or from the service provider operating the host computer 2002, or both. While the OTT connection 2016 is active, the network infrastructure may further take decisions by which it dynamically changes the routing (e.g., on the basis of load balancing consideration or reconfiguration of the network).

The wireless connection 2026 between the UE 2014 and the base station 2018 is in accordance with the teachings of the embodiments described throughout this disclosure. One or more of the various embodiments improve the performance of OTT services provided to the UE 2014 using the OTT connection 2016, in which the wireless connection 2026 forms the last segment.

A measurement procedure may be provided for the purpose of monitoring data rate, latency, and other factors on which the one or more embodiments improve. There may further be an optional network functionality for reconfiguring the OTT connection 2016 between the host computer 2002 and the UE 2014, in response to variations in the measurement results. The measurement procedure and/or the network functionality for reconfiguring the OTT connection 2016 may be implemented in the software 2010 and the hardware 2004 of the host computer 2002 or in the software 2040 and the hardware 2034 of the UE 2014, or both. In some embodiments, sensors (not shown) may be deployed in or in association with communication devices through which the OTT connection 2016 passes; the sensors may participate in the measurement procedure by supplying values of the monitored quantities exemplified above, or supplying values of other physical quantities from which the software 2010, 2040 may compute or estimate the monitored quantities. The reconfiguring of the OTT connection 2016 may include message format, retransmission settings, preferred routing, etc.; the reconfiguring need not affect the base station 2018, and it may be unknown or imperceptible to the base station 2018. Such procedures and functionalities may be known and practiced in the art. In certain embodiments, measurements may involve proprietary UE signaling facilitating the host computer 2002's measurements of throughput, propagation times, latency, and the like. The measurements may be implemented in that the software 2010 and 2040 causes messages to be transmitted, in particular empty or ‘dummy’ messages, using the OTT connection 2016 while it monitors propagation times, errors, etc.

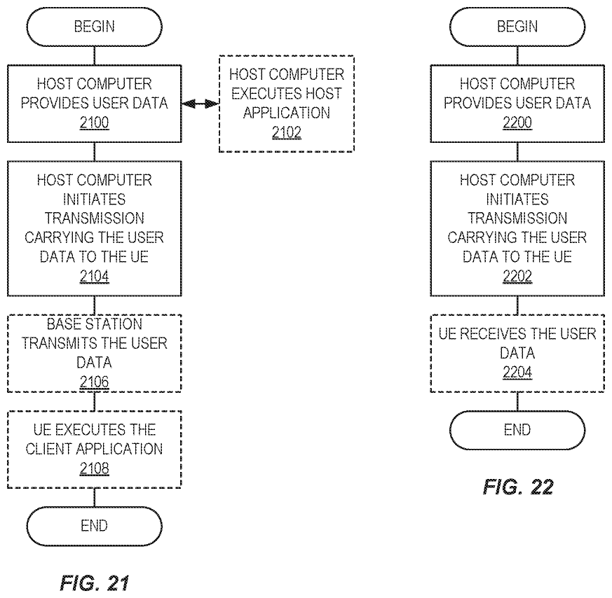

FIG. 21 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 21 will be included in this section. In step 2100, the host computer provides user data. In sub-step 2102 (which may be optional) of step 2100, the host computer provides the user data by executing a host application. In step 2104, the host computer initiates a transmission carrying the user data to the UE. In step 2106 (which may be optional), the base station transmits to the UE the user data which was carried in the transmission that the host computer initiated, in accordance with the teachings of the embodiments described throughout this disclosure. In step 2108 (which may also be optional), the UE executes a client application associated with the host application executed by the host computer.

FIG. 22 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 22 will be included in this section. In step 2200 of the method, the host computer provides user data. In an optional sub-step (not shown) the host computer provides the user data by executing a host application. In step 2202, the host computer initiates a transmission carrying the user data to the UE. The transmission may pass via the base station, in accordance with the teachings of the embodiments described throughout this disclosure. In step 2204 (which may be optional), the UE receives the user data carried in the transmission.

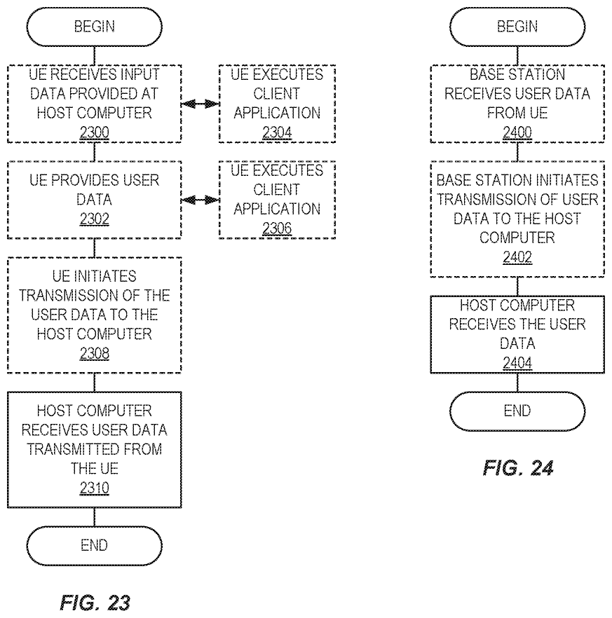

FIG. 23 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 23 will be included in this section. In step 2300 (which may be optional), the UE receives input data provided by the host computer. Additionally or alternatively, in step 2302, the UE provides user data. In sub-step 2304 (which may be optional) of step 2300, the UE provides the user data by executing a client application. In sub-step 2306 (which may be optional) of step 2302, the UE executes a client application which provides the user data in reaction to the received input data provided by the host computer. In providing the user data, the executed client application may further consider user input received from the user. Regardless of the specific manner in which the user data was provided, the UE initiates, in sub-step 2308 (which may be optional), transmission of the user data to the host computer. In step 2310 of the method, the host computer receives the user data transmitted from the UE, in accordance with the teachings of the embodiments described throughout this disclosure.

FIG. 24 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 24 will be included in this section. In step 2400 (which may be optional), in accordance with the teachings of the embodiments described throughout this disclosure, the base station receives user data from the UE. In step 2402 (which may be optional), the base station initiates transmission of the received user data to the host computer. In step 2404 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some exemplary embodiments of the present disclosure are as follows.

Embodiment 1: A method performed by a wireless device for reporting

Channel State Information, CSI, is provided. The method comprising one or more of: receiving (1000) a selected subset of Frequency Domain, FD, basis vectors among a full set (e.g., N₃) of FD basis vectors from a network node (e.g., gNB), computing (1006) a CSI corresponding to an enhanced (e.g., Rel-16) type II port selection codebook using the selected FD basis vectors, and reporting (1008) the CSI to the network node.

Embodiment 2: The full set of FD basis vectors comprises a set of orthogonal complex vectors having a length that equals N₃.

Embodiment 3: Receiving (800) the subset of FD basis vectors comprises receiving (1000-1) the selected subset of FD basis vectors in a Medium Access Control, MAC, Control Element, CE.

Embodiment 4: The MAC CE comprises a field (e.g., a bitmap of N₃ bits or a bitmap of ┌log₂(N₃)┐ configured to indicate the selected subset of FD basis vectors among the full set of FD basis vectors.

Embodiment 5: The MAC CE comprises a plurality of fields (e.g., a bitmap of N₃ bits or a bitmap of ┌log₂(N₃)┐ each configured to indicate the selected subset of FD basis vectors among the full set of FD basis vectors for a respective one of a plurality of layers.

Embodiment 6: Receiving (1000) the subset of FD basis vectors comprises receiving (1000-2) the selected subset of FD basis vectors in a Downlink Control Information, DCI.

Embodiment 7: The DCI comprises a field (e.g., CSI-AssociatedReportConfigInfo) corresponding to a codepoint and configured to indicate the selected subset of FD basis vectors among the full set of FD basis vectors.

Embodiment 8: The method also includes receiving (1002), from the network node, an indication (e.g., via MAC CE or DCI) that indicates: one or more non-zero power CSI-Reference Signal, CSI-RS, ports, or one or more zero power CSI-RS ports. The method also includes performing (1004) channel measurements on the one or more non-zero power CSI-RS ports.

Embodiment 9: Computing (1006) the CSI using the selected FD basis vectors comprises computing (1006-1) the CSI based on all of the selected subset of FD basis vectors. Reporting (1008) the CSI comprises not reporting (1008-1) indices i_{1,5} and i_{1,6,l} as part of an enhanced type II port selection PMI report.

Embodiment 10: Computing (1006) the CSI using the selected FD basis vectors comprises computing (1006-2) the CSI based on a subset of the selected subset of FD basis vectors. Reporting (1008) the CSI comprises reporting (1008-2) indices i_{1,5} and i_{1,6,l} as part of an enhanced type II port selection PMI report.

Embodiment 11: The method also includes providing user data and forwarding the user data to a host computer via the transmission to the base station.

Embodiment 12: A method performed by a base station (e.g., gNB) for enabling a wireless device to report Channel State Information, CSI, is provided. The method comprising one or more of: indicating (1102) a selected subset of Frequency Domain, FD, basis vectors among a full set (e.g., N₃) of FD basis vectors to the wireless device and receiving (1108) a CSI from the wireless device.

Embodiment 13: The method also includes comprising determining (1100) the subset of FD basis vectors among the full set of FD basis vectors based on one or more uplink measurements performed on SRS received from the wireless device.

Embodiment 14: Indicating (1102) the subset of FD basis vectors comprises indicating (1102-1) the selected subset of FD basis vectors in a Medium Access Control, MAC, Control Element, CE.

Embodiment 15: The MAC CE comprises a field (e.g., a bitmap of N₃ bits or a bitmap of ┌log₂(N₃)┐ configured to indicate the selected subset of FD basis vectors among the full set of FD basis vectors.

Embodiment 16: The MAC CE comprises a plurality of fields (e.g., a bitmap of N₃ bits or a bitmap of ┌log₂(N₃)┐ each configured to indicate the selected subset of FD basis vectors among the full set of FD basis vectors for a respective one of a plurality of layers.

Embodiment 17: Indicating (1102) the subset of FD basis vectors comprises receiving (1102-2) the selected subset of FD basis vectors in a Downlink Control Information, DCI.

Embodiment 18: The DCI comprises a field (e.g., CSI-AssociatedReportConfigInfo) corresponding to a codepoint and configured to indicate the selected subset of FD basis vectors among the full set of FD basis vectors.

Embodiment 19: The method also includes providing (1104), to the wireless device, an indication (e.g., via MAC CE or DCI) that indicates: one or more non-zero power CSI-Reference Signal, CSI-RS, ports or one or more zero power CSI-RS ports.

The method also includes receiving (1106), from the wireless device, channel measurements performed based on the one or more non-zero power CSI-RS ports.

Embodiment 20: Receiving (1108) the CSI comprises not receiving (1108-1) or receiving (1108-2) indices i_{1,5} and i_{1,6,l} as part of an enhanced type II port selection PMI report.

Embodiment 21: The method also includes obtaining user data and forwarding the user data to a host computer or a wireless device.

Embodiment 22: A wireless device for reporting Channel State Information, CSI is provided. The wireless device comprising processing circuitry is configured to perform any of the steps of any of the embodiments performed by the wireless device. The wireless device also includes power supply circuitry configured to supply power to the wireless device.

Embodiment 23: A base station for enabling a wireless device to report Channel State Information, CSI, is provided. The base station comprising processing circuitry configured to perform any of the steps of any of the embodiments performed by the base station. The base station also includes power supply circuitry configured to supply power to the base station.

Embodiment 24: A User Equipment, UE, for reporting Channel State Information, CSI, is provided. The UE includes an antenna configured to send and receive wireless signals. The UE also includes radio front-end circuitry connected to the antenna and to processing circuitry, and configured to condition signals communicated between the antenna and the processing circuitry. The processing circuitry being configured to perform any of the steps of any of the embodiments performed by the wireless device. The UE also includes an input interface connected to the processing circuitry and configured to allow input of information into the UE to be processed by the processing circuitry. The UE also includes an output interface connected to the processing circuitry and configured to output information from the UE that has been processed by the processing circuitry. The UE also includes a battery connected to the processing circuitry and configured to supply power to the UE.

Embodiment 25: A communication system including a host computer. The host computer includes processing circuitry configured to provide user data and a communication interface configured to forward the user data to a cellular network for transmission to a User Equipment, UE. The cellular network comprises a base station having a radio interface and processing circuitry, the base station's processing circuitry configured to perform any of the steps of any of the embodiments performed by the base station.

Embodiment 26: The communication system further includes the base station.

Embodiment 27: The communication system further includes the UE, wherein the UE is configured to communicate with the base station.

Embodiment 28: The processing circuitry of the host computer is configured to execute a host application, thereby providing the user data. The UE comprises processing circuitry configured to execute a client application associated with the host application.

Embodiment 29: A method implemented in a communication system including a host computer, a base station, and a User Equipment, UE. The method includes, at the host computer, providing user data. The method also includes, at the host computer, initiating a transmission carrying the user data to the UE via a cellular network comprising the base station, wherein the base station performs any of the steps of any of the embodiments performed by the base station.

Embodiment 30: The method further comprising, at the base station, transmitting the user data.

Embodiment 31: The user data is provided at the host computer by executing a host application, the method further comprising, at the UE, executing a client application associated with the host application.

Embodiment 32: A User Equipment, UE, configured to communicate with a base station. The UE includes a radio interface and processing circuitry configured to perform the method of the previous 3 embodiments.

Embodiment 33: A communication system including a host computer. The host computer includes processing circuitry configured to provide user data and a communication interface configured to forward user data to a cellular network for transmission to a User Equipment, UE. The UE comprises a radio interface and processing circuitry, the UE's components configured to perform any of the steps of any of the embodiments performed by the wireless device.

Embodiment 34: The cellular network further includes a base station configured to communicate with the UE.

Embodiment 35: The processing circuitry of the host computer is configured to execute a host application, thereby providing the user data. The UE's processing circuitry is configured to execute a client application associated with the host application.

Embodiment 36: A method implemented in a communication system including a host computer, a base station, and a User Equipment, UE. The method includes, at the host computer, providing user data. The method also includes, at the host computer, initiating a transmission carrying the user data to the UE via a cellular network comprising the base station. The UE performs any of the steps of any of the embodiments performed by the wireless device.

Embodiment 37: The method also includes, comprising at the UE, receiving the user data from the base station.

Embodiment 38: A communication system including a host computer. The host computer includes a communication interface configured to receive user data originating from a transmission from a User Equipment, UE, to a base station. The UE comprises a radio interface and processing circuitry. The UE's processing circuitry configured to perform any of the steps of any of the embodiments performed by the wireless device.

Embodiment 39: The communication system further includes the UE.

Embodiment 40: The communication system further includes the base station. The base station comprises a radio interface configured to communicate with the UE and a communication interface configured to forward to the host computer the user data carried by a transmission from the UE to the base station.

Embodiment 41: The processing circuitry of the host computer is configured to execute a host application. The UE's processing circuitry is configured to execute a client application associated with the host application, thereby providing the user data.

Embodiment 42: The processing circuitry of the host computer is configured to execute a host application, thereby providing request data. The UE's processing circuitry is configured to execute a client application associated with the host application, thereby providing the user data in response to the request data.

Embodiment 43: A method implemented in a communication system including a host computer, a base station, and a User Equipment, UE. The method includes, at the host computer, receiving user data transmitted to the base station from the UE. The UE performs any of the steps of any of the embodiments performed by the wireless device.

Embodiment 44: The method also includes, at the UE, providing the user data to the base station.

Embodiment 45: The method also includes, at the UE, executing a client application, thereby providing the user data to be transmitted. The method also includes, at the host computer, executing a host application associated with the client application.

Embodiment 46: The method also includes, at the UE, executing a client application. The method also includes, at the UE, receiving input data to the client application, the input data being provided at the host computer by executing a host application associated with the client application. The user data to be transmitted is provided by the client application in response to the input data.

Embodiment 47: A communication system including a host computer comprising a communication interface configured to receive user data originating from a transmission from a User Equipment, UE, to a base station. The base station comprises a radio interface and processing circuitry. The base station's processing circuitry is configured to perform any of the steps of any of the embodiments performed by the base station.

Embodiment 48: The communication system further includes the base station.

Embodiment 49: The communication system further includes the UE. The UE is configured to communicate with the base station.

Embodiment 50: The processing circuitry of the host computer is configured to execute a host application. The UE is configured to execute a client application associated with the host application, thereby providing the user data to be received by the host computer.

Embodiment 51: A method implemented in a communication system including a host computer, a base station, and a User Equipment, UE. The method comprising, at the host computer, receiving, from the base station, user data originating from a transmission which the base station has received from the UE. The UE performs any of the steps of any of the embodiments performed by the wireless device.

Embodiment 52: The method also includes, at the base station, receiving the user data from the UE.

Embodiment 53: The method also includes, at the base station, initiating a transmission of the received user data to the host computer.

Embodiment 54: A method for signaling to a user equipment, UE, from a network (e.g., eNB) a selected subset of frequency domain, FD, basis vectors among a full set, N₃, of FD basis vectors. The FD basis vectors comprise a set of orthogonal complex vectors having a length that equals N₃. The method comprising the UE using the selected subset of FD basis vectors to compute a CSI corresponding to an enhanced (e.g., 3GPP Rel-16) type II port selection codebook.

Embodiment 55: The selected subset of FD basis vectors is signaled via a medium access control, MAC, control element, CE.

Embodiment 56: The NAC CE comprises a field of length N₃, each bit in the field indicates whether or not a FD basis vector among the full set of FD basis vectors is selected.

Embodiment 57: The MAC CE is configured to indicate up to a maximum number of FD basis vectors.

Embodiment 58: The maximum number of FD basis vectors is determined via one or more higher layer configured parameters.

Embodiment 59: The selected subset of FD basis vectors is signaled via downlink control information, DCI.

Embodiment 60: The UE computes the CSI using all of the selected FD basis vectors.

Embodiment 61: The UE does not feedback report indices i_{1,5} and i_{1,6,l} as part of an enhanced type II port selection PMI report.

Embodiment 62: The UE computes the CSI using a subset of the selected FD basis vectors.

Embodiment 63: The UE reports one or more of the indices i_{1,5} and i_{1,6,l} as part of an enhanced type II port selection PMI report.

Embodiment 64: The network further indicates a subset of non-zero power CSI-RS ports among a set of configured CSI-RS ports to the UE to perform channel measurement.

Embodiment 65: The network further indicates zero power CSI-RS ports among a set of configured CSI-RS ports to the UE.

Embodiment 66: The UE performs channel measurements on one or more CSI-RS ports not indicated as zero power CSI-RS ports in the set of CSI-RS ports.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
BWP Bandwidth Part
CPU Central Processing Unit
CQI Channel Quality Indicators
CSI Channel State Information
DCI Downlink Control Information
DL Downlink
DN Data Network
DSP Digital Signal Processor
eNB Enhanced or Evolved Node B
EPS Evolved Packet System
E-UTRA Evolved Universal Terrestrial Radio Access
FD Frequency Domain
FDD Frequency Division Duplex
FPGA Field Programmable Gate Array
gNB New Radio Base Station
gNB-DU New Radio Base Station Distributed Unit
HSS Home Subscriber Server
IMR Interference Measurement Resource
IoT Internet of Things
IP Internet Protocol
LTE Long Term Evolution
MAC Medium Access Control
MCS Modulation and Coding Scheme
MIMO Multiple-Input Multiple-Output
MME Mobility Management Entity
MTC Machine Type Communication
NEF Network Exposure Function
NF Network Function
NR New Radio
NRF Network Function Repository Function
NSSF Network Slice Selection Function
NZP Non-Zero Power
OFDM Orthogonal Frequency Division Multiplexing
OTT Over-the-Top
PC Personal Computer
PCF Policy Control Function
PDSCH Physical Downlink Shared Channel
P-GW Packet Data Network Gateway
PMI Precoder Matrix Indicator
PS Port Selection
PUSCH Physical Uplink Shared Channel
QoS Quality of Service
RAM Random Access Memory
RAN Radio Access Network
RE Resource Element
RI Rank Indicator
ROM Read Only Memory
RRH Remote Radio Head
RS Reference Signal
RTT Round Trip Time
SCEF Service Capability Exposure Function
SD Spatial Domain
SMF Session Management Function
SRS Sounding Reference Signal
TDD Time Division Duplex
TFRE Time/Frequency Resource Element
UDM Unified Data Management
UE User Equipment
UL Uplink
UPF User Plane Function

Those skilled in the art will recognize improvements and modifications to the embodiments of the present disclosure. All such improvements and modifications are considered within the scope of the concepts disclosed herein.

1. A method performed by a wireless device for reporting Channel State Information, CSI, comprising:
receiving an indication indicating a subset of Frequency Domain, FD, basis vectors among a full set of FD basis vectors per a group of transmission layers from a radio network node;
computing a CSI corresponding to an enhanced type II port selection codebook using the indicated subset of FD basis vectors; and
reporting the CSI to the radio network node.

2. The method of claim 1, wherein the full set of FD basis vectors comprises a set of orthogonal complex vectors having a length that equals N₃.

3. The method of claim 2, wherein N₃ is determined by higher layer parameters numberOfPMISubbandsPerCQISubband and csi-ReportingBand.

4. The method of claim 1, wherein receiving the indicator indicating the subset of FD basis vectors comprises receiving the indication indicating the subset of FD basis vectors in a control message.

5. The method of claim 4, wherein the control message is a Medium Access Control, MAC, Control Element, CE.

6. The method of claim 5, wherein the MAC CE comprises a field configured to indicate the subset of FD basis vectors among the full set of FD basis vectors.

7. The method of claim 6, wherein the field in the MAC CE comprises one of:
a bitmap of N₃ bits; and
a bitmap of ┌log₂(N₃)┐ bits.

8. The method of claim 5, wherein the MAC CE comprises a plurality of fields each configured to indicate the subset of FD basis vectors among the full set of FD basis vectors for a respective one of a plurality of layers.

9. The method of claim 8, wherein each of the plurality of fields in the MAC CE comprises one of:
a bitmap of N₃ bits; and
a bitmap of ┌log₂(N₃)┐ bits.

10. The method of claim 1, wherein receiving the indication indicating subset of FD basis vectors comprises receiving the indication indicating the subset of FD basis vectors in a Downlink Control Information, DCI.

11. The method of claim 10, wherein the DCI comprises a field corresponding to a codepoint and configured to indicate the subset of FD basis vectors among the full set of FD basis vectors.

12. The method of claim 11, wherein the field in the DCI comprises a CSI-AssociatedReportConfigInfo corresponding to the codepoint.

13. The method of claim 1, further comprising:
receiving, from the radio network node, a configuration of a CSI-Reference Signal, CSI-RS, resource with a set of CSI-RS ports and an indication that indicates one or more of:
one or more non-zero power CSI-RS ports in the CSI-RS resource; and
one or more zero power CSI-RS ports in the CSI-RS resource; and
performing channel measurements based on the one or more non-zero power CSI-RS ports.

14. The method of claim 1, wherein:
computing the CSI using the indicated subset of FD basis vectors comprises computing the CSI based on all of the indicated subset of FD basis vectors; and
reporting the CSI comprises not reporting indices indicating a subset of the indicated subset of FD basis vectors as part of an enhanced type II port selection Precoding Matrix Indicator, PMI, report.

15. The method of claim 1, wherein:
computing the CSI using the indicated subset of FD basis vectors comprises computing the CSI based on a selected subset of the indicated subset of FD basis vectors; and
reporting the CSI comprises reporting indices indicating the selected subset of the indicated subset of FD basis vectors as part of an enhanced type II port selection Precoding Matrix Indicator, PMI, report.

16. A wireless device comprising processing circuitry configured to cause the wireless device to:
receive an indication indicating a subset of Frequency Domain, FD, basis vectors among a full set of FD basis vectors per a group of transmission layers from a radio network node;
compute a CSI corresponding to an enhanced type II port selection codebook using the indicated subset of FD basis vectors; and
report the CSI to the radio network node.

17. (canceled)

18. A method performed by a radio network node for enabling a wireless device to report Channel State Information, CSI, comprising:
providing an indication indicating a subset of Frequency Domain, FD, basis vectors among a full set of FD basis vectors per a group of transmission layers to the wireless device; and
receiving a CSI from the wireless device.

19. The method of claim 18, further comprising determining the subset of FD basis vectors among the full set of FD basis vectors based on one or more uplink measurements performed on a Sounding Reference Signal, SRS, received from the wireless device.

20. The method of claim 18, wherein providing the indication indicating the subset of FD basis vectors comprises providing the indication indicating the subset of FD basis vectors in a control message.

21. The method of claim 20, wherein the control message is a Medium Access Control, MAC, Control Element, CE.

22. The method of claim 21, wherein the MAC CE comprises a field configured to indicate the indicated subset of FD basis vectors among the full set of FD basis vectors.

23. The method of claim 22, wherein the field in the MAC CE comprises one of:
a bitmap of N₃ bits; and
a bitmap of ┌log₂(N₃)┐ bits.

24. The method of claim 21, wherein the MAC CE comprises a plurality of fields each configured to indicate the indicated subset of FD basis vectors among the full set of FD basis vectors for a respective one of a plurality of layers.

25. The method of claim 24, wherein each of the plurality of fields in the MAC CE comprises one of:
a bitmap of N₃ bits; and
a bitmap of ┌log₂(N₃)┐ bits.

26. The method of claim 18, wherein providing the indication indicating the subset of FD basis vectors comprises providing the indication indicating the subset of FD basis vectors in a Downlink Control Information, DCI.

27-30. (canceled)

31. A radio network node comprising processing circuitry configured to cause the radio network node to:
provide an indication indicating a subset of Frequency Domain, FD, basis vectors among a full set of FD basis vectors per a group of transmission layers to the wireless device; and
receive a CSI from the wireless device.

32. (canceled)
